(19) United States
(12) Patent Application Publication
(10) Pub. No.: US 2024/0304779 A1
(43) Pub. Date: Sep. 12, 2024

(54) COMPOSITE FIBER INKS AND ELECTRODES AND APPLICATIONS OF SAME

(71) Applicant: VANDERBILT UNIVERSITY, Nashville (TN)

(72) Inventors: Peter N. Pintauro, Brentwood, TN (US); Ryszard Wycisk, Nashville, TN (US)

(21) Appl. No.: 18/567,888

(22) PCT Filed: Dec. 6, 2021
(86) PCT No.: PCT/US2021/061967

§ 371 Date: Dec. 7, 2023

Related U.S. Application Data
(63) Continuation-in-part of application No. 17/341,487, filed on Jun. 8, 2021.

(51) Int. Cl. H01M 4/04; B05B 5/025; D01D 1/02; D01D 5/00; D01F 1/09; D01F 6/12; D01F 6/16; D01F 6/18; D01F 6/60; D04H 1/4282; D04H 1/43; D04H 1/4318; D04H 1/4334; D04H 1/728; H01M 4/02; H01M 4/134; H01M 4/1395; H01M 4/38; H01M 4/62; H01M 10/0525

(52) U.S. Cl. CPC H01M 4/0404; B05B 5/0255; D01D 1/02; D01D 5/0038; D01D 5/0076; D01F 1/09; D01F 6/12; D01F 6/16; D01F 6/18; D01F 6/60; D04H 1/4282; D04H 1/43; D04H 1/4318; D04H 1/4334; D04H 1/728; H01M 4/0419; H01M 4/134; H01M 4/1395; H01M 4/386; H01M 4/622; D10B 2321/042; D10B 2321/08; D10B 2321/10; D10B 2331/02; D10B 2505/00; H01M 2004/027; H01M 10/0525

(57) ABSTRACT

An ink and electrodes fabricated with the ink. The ink includes a dispersion of fibers in at least one solvent. Said fibers have one or more fiber types, where at least one type of said fibers comprises at least one catalyst for an electrochemical reaction and at least one binder polymer.

### CROSS-REFERENCE TO RELATED PATENT APPLICATIONS

This application is a continuation in part of, and claims priority to and the benefit of U.S. patent application Ser. No. 17/341,487, filed Jun. 8, 2021, which itself claims priority to and the benefit of U.S. Provisional Patent Application Ser. No. 63/035,918, filed Jun. 8, 2020, which are incorporated herein by reference in their entireties.

### STATEMENT AS TO RIGHTS UNDER FEDERALLY-SPONSORED RESEARCH

This invention was made with government support under Contract No. DE-EE0007653 awarded by the Department of Energy. The government has certain rights in the invention.

### FIELD OF THE INVENTION

The invention relates generally to the field of materials, and more particularly to composite fiber inks and electrodes, and electrochemical devices having the composite fiber electrodes.

### BACKGROUND OF THE INVENTION

Fiber electrodes that can be used in electrochemical devices are usually fabricated by electrospinning dispersions of polymers and catalyst particles in solvents. It is known that the performance of an electrochemical device such as a battery or a fuel cell is dependent on the electrode fabricating processes and the electrode materials, which directly impact the structural/morphological characteristics of the electrodes. The electrochemical behavior of a particle/polymer-based electrode is often dependent on the ink which is used to create the electrodes. Therefore, there is a need to develop novel inks that are used to fabricate electrodes for improvement of the performance of electrochemical devices.

### SUMMARY OF THE INVENTION

One of the objectives of this invention is to develop electrode inks containing pre-formed fibers and fiber electrodes made with the inks for an electrochemical device. The ink contains one or more different types of fibers dispersed in a solvent, where at least one of the fiber types is a fiber containing one or more particle types and one or more polymer types, where at least one type of the particles in a particle/polymer fiber is electrochemically active particles. The electrodes are made by coating or spraying the ink onto substrates.

In one aspect, the invention relates to an electrode ink comprising a dispersion of fibers in at least one solvent, wherein said fibers have one or more fiber types, wherein at least one type of said fibers comprises at least one catalyst for an electrochemical reaction and at least one binder polymer.

In one embodiment, the at least one catalyst comprises electrochemically active particles, or electrically conductive particles.

In one embodiment, the at least one catalyst comprises a catalyst composed of a metal or alloy on a catalyst support, or a metal or alloy with no support.

In one embodiment, the at least one catalyst comprises Pt, Pd, Rh, Ru, Ir, IrO₂, Au, Ag, Ni, Zn, Ti, Mo, Co, Fe, W, Cu, Cr, Ta, or a mixture or blend or alloy thereof.

In one embodiment, the at least one catalyst comprises one or more of a platinum-group-metal (PGM) on the catalyst support; PGM-free particles including Fe—N—C particles, Ir, IrO₂, precious metal alloy catalysts on a catalyst support including Pt/C, PtCo/C or PtNi/C; and PGM black catalysts with no support including Pt-black, Pd-black, Pd-black alloys and Pt-black alloys, carbon and graphite powders, detonation diamond powder, core-shell and shape controlled catalyst particles, and catalysts for oxygen reduction in alkaline media including Ag and Ni.

In one embodiment, the catalyst support comprises carbon, or oxides or carbides of metals including Si, Mo, Ti, or Al.

In one embodiment, the at least one binder polymer is an ionomer comprising uncharged repeat units and repeat units with charged/ionizable repeating units.

In one embodiment, the ionomer binder is a fluorinated ionomer.

In one embodiment, the fluorinated ionomer is a perfluorinated sulfonic acid ionomer.

In one embodiment, the at least one solvent comprises water,

In one embodiment, the solvent is a water/organic mixture.

In one embodiment, an organic component of the water/organic solvent is an alcohol.

In one embodiment, the alcohol is ethanol.

In one embodiment, the at least one solvent further comprises a dispersion of at least one fluorinated polymer.

In one embodiment, the at least one fluorinated polymer is polytetrafluoroethylene (PTFE), polyvinylidene fluoride (PVDF), or fluorinated ethylene propylene (FEP).

In one embodiment, the at least one solvent further comprises one or more ionic or nonionic surfactants, and/or one or more polymer dispersants.

In one embodiment, the at least one solvent further comprises one or more particles.

In one embodiment, the one or more particles are ceria particles and/or one or more electrocatalyst (electrochemically active) particles.

In one embodiment, the at least one catalyst comprises two or more different catalysts, and the at least one binder polymer comprises two or more different polymers.

In one embodiment, the fibers contain at least one type of polymer and nanowires and/or nanotubes.

In one embodiment, the fibers contain at least one type of polymer and at least one type of particle and at least one type of nanowire or nanotube.

In one embodiment, the at least one type of said fibers further comprises a carrier polymer.

In one embodiment, the carrier polymer comprises polyethylene oxide (PEO), poly(acrylic acid) (PAA), polyvinyl alcohol (PVA), polyvinylpyrrolidone (PVP), polyethylene glycol (PEG), or a mixture thereof.

In one embodiment, the at least one catalyst comprises Pt/C, Pt/Co/C, PtNi/C, or ceria particles and the at least one binder polymer comprises perfluorosulfonic acid.

In one embodiment, at least another type of said fibers comprises fibers containing Ir or IrO₂, or ceria particles in a binder of one or more polymers.

In one embodiment, said fibers comprise two or more different particle/polymer fiber types, wherein each particle/polymer fiber type comprises a catalyst and a polymer.

In one embodiment, said fibers comprise one or more different particle/polymer fiber types and one or more different polymer fiber type, wherein each particle/polymer fiber type comprises a catalyst and a polymer, and each polymer fiber type comprises one or more polymers.

In one embodiment, said fibers differ by one or more of a type of particles; a type of the binder; a binder/catalyst ratio; intra-fiber porosity; fiber morphology; and particle loading.

In one embodiment, said fibers are pre-formed by needle or needless electrospinning, gas jet spinning, or centrifugal spinning, foam electrospinning, or some hybrid combination thereof.

In another aspect, the invention relates to an electrode, being fabricated using the ink of any one of the above disclosed inks.

In one embodiment, the electrode is fabricated with a single ink with a uniform ink distribution in the electrode thickness and/or lateral electrode direction.

In yet another aspect, the invention relates to an electrode, being fabricated using multiple different inks, each ink has a formulation according to any one or more of the above disclosed inks. At least one type of said fibers in each ink contains one or more catalyst and one or more polymers.

In one embodiment, each of said multiple different inks comprises pre-formed fibers, wherein the electrode has a layered morphology in the electrode thickness direction, wherein the layers differ in thickness and/or fiber morphology and/or fiber composition.

In one embodiment, the electrode comprises multiple layers, wherein each layer is made by a respective ink, wherein said inks differ in fiber content, fiber diameter and porosity, fiber composition, solvent, type and the presence or absence of dispersed polymer droplets and/or surfactant.

In one embodiment, the electrode is fabricated by a spraying, electrospraying, ultrasonically spraying, or coating process.

In one embodiment, the coating process is a die-slot coating process, a gravure coating process, or a process that utilizes Meyer rods or similar devices.

In one embodiment, the electrode is an electrospun fibrous mat electrode comprising a catalyst powder, an ionomer, a dispersed uncharged polymer and a carrier polymer.

In one embodiment, the electrode is fabricated with two or more inks, wherein the two or more inks are sequentially deposited in the electrode thickness direction.

In one embodiment, the electrode is fabricated with two or more inks, wherein the two or more inks are simultaneously deposited by a spraying, electrospraying, ultrasonic spraying or similar technique during electrode fabrication.

In one embodiment, the electrode is fabricated with two or more different inks, wherein the two or more inks are simultaneously deposited by a spraying, electrospraying, ultrasonic spraying or similar technique during electrode fabrication, wherein the flow rate of ink deposition for each ink is continuously varied to create a continuous gradient electrode composition.

In one embodiment, the ink with fibers is sprayed onto a pre-formed particle/polymer fiber mat or the ink with fibers is sprayed during the spinning of a particle/polymer fiber mat.

In one embodiment, the ink with fibers is sprayed onto a preformed polymer fiber mat or the ink with fibers is sprayed during the spinning of a polymer fiber mat.

In one embodiment, the electrode is fabricated from two or more inks, wherein a gradient composition exists in the fiber composition in the planar electrode direction and/or in the electrode thickness direction.

In one embodiment, the electrode is fabricated from two or more inks, wherein a variation exists in fiber composition in the direction perpendicular and/or parallel to the electrode thickness.

In one embodiment, the electrode is a Si anode for Li-ion batteries.

In a further aspect, the invention relates to an electrode, formed by coating an electrode ink comprising a single fiber type or multiple fiber types and a solvent on a membrane/separator or on a conductive substrate to form a single fiber-type or multi-fiber type electrode after solvent removal. The fibers are pre-formed before preparation of the electrode ink via a fiber spinning process. The fibers comprises one or more polymers, and/or one or more types of particles.

In one embodiment, the electrode ink further comprises the pre-formed fibers and a polymeric dispersed in the solvent.

In one embodiment, the electrode ink comprises the pre-formed fibers and micellar droplets (particles) of a water-insoluble polymer dispersed in the solvent, wherein the solvent is a water or water/alcohol solvent.

In one embodiment, the water-insoluble polymer comprises a perfluorosulfonic acid polymer, or a hydrocarbon polymer with negatively or positively charged ion-exchange groups.

In one embodiment, said one or more types of particles comprise catalyst particles or particles of an electrochemically active material, optionally mixed with a polymeric binder.

In one embodiment, said one or more types of particles comprise micellar polymer droplets.

In one embodiment, the fiber spinning process comprises electrospinning, centrifugal spinning, foam electrospinning, or gas jet fiber spinning.

In one embodiment, said coating the electrode ink is performed by spraying coating, electrospraying, ultrasonic spraying, slot-die coating, gravure coating, or the likes.

In one embodiment, the pre-formed fibers in the electrode ink comprise only one type of fibers.

In one embodiment, the pre-formed fibers in the electrode ink comprise two or more different types of fibers, wherein each type of the fibers differs in the type/amount of particles, and/or the type/amount of a polymer binder, and/or the fiber morphology including fiber diameter and internal fiber porosity.

In one embodiment, the electrode is a layered electrode structure having multiple layers of composite fiber deposited onto one another.

In one embodiment, the electrode is a layered or gradient/near-gradient-composition electrode structure formed by coating or spraying multiple different fiber-containing inks onto one another sequentially.

In one embodiment, each of said multiple different fiber-containing inks differs in fiber type/structure including fiber diameter and porosity, fiber composition, and binder type and amount.

In one embodiment, the thickness and porosity of each layer are fixed or variable.

In one aspect, the invention relates to an electrochemical device, comprising at least one electrode of any one of the above disclosed electrodes.

In one embodiment, the ink contains fibers containing Pt/C, PtCo/C, or PtNi/C catalyst particles, a perfluorosulfonic acid ionomer, and poly(acrylic acid) that are dispersed in a water/ethanol solvent.

In one embodiment, the ink was prepared using electrospun fibers compose of Pt/C, PtCo/C, or PtNi/C particles, a perfluorosulfonic acid ionomer, and polyethylene oxide.

In one embodiment, the electrode made from inks with fibers is used in a membrane-electrode-assembly for a proton-exchange membrane fuel cell or a hydroxide exchange membrane fuel cell.

In one embodiment, the electrode made from inks with fibers is used in a battery, such as a Li-ion battery or Na-ion battery.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the present invention and, together with the written description, serve to explain the principles of the invention. Wherever possible, the same reference numbers are used throughout the drawings to refer to the same or like elements of an embodiment.

FIGS. 1A-1B show respectively a schematic of a dual fiber Si-PAA/C-PAN anode mat fabrication and an SEM image of an exemplary dual fiber mat, according to embodiments of the invention.

FIG. 2 shows cycling results of an anode fabricated from electrospun dual fiber mat containing about 70 wt. % of Si/PAA (about 50/50) and about 30 wt. % of C/PAN (about 63/37) fibers, according to embodiments of the invention.

FIG. 3 shows cycling results of three dual fiber Si/PAA+C/PAN dual fiber anodes with different Si areal loading: (a) about 0.694 mg_{Si}/cm², about 50 wt. % PAA in Si/PAA fibers, (b) about 0.987 mg_{Si}/cm², about 50 wt. % PAA in Si/PAA fibers, and (c) about 1.331 mg_{Si}/cm², about 60 wt. % PAA in Si/PAA fibers, according to embodiments of the invention. The C/PAN fibers were of the same composition in all three anodes and contained about 63 wt. % C and about 37 wt. % PAN.

FIG. 4 shows a schematic of an electrospun/electrosprayed fiber mat fabrication, according to embodiments of the invention.

FIGS. 5A-5B show respectively (FIG. 5A) an SEM image of an as-spun Si/PAA-C/PVDF raw mat with composition: about 20 wt. % C, about 45 wt. % Si, about 35 wt. % binder (about 3 wt. % PVDF, about 32 wt. % PAA) scale bar=2 μm, and (FIG. 5B) cycling performance of the Si/PAA-C/PVDF anode, according to embodiments of the invention.

FIGS. 6A-6B show SEM images of electrospun Si-PAA/electrosprayed C-PAI mats, according to embodiments of the invention. FIG. 6A: As spun raw mat. FIG. 6B: Cross section of welded and compacted mat.

FIG. 7 shows gravimetric capacity (mAh/g) vs cycle number for Si/PAA electrospin/C-PAI electrospray anodes at two loadings (about 1.01 mg/cm² and about 1.87 mg/cm²), according to embodiments of the invention.

FIGS. 8A-8B show scanning electron micrographs of re-dispersed fiber electrodes at 3 kX magnification (FIG. 8A) and 10 kX magnification (FIG. 8B), according to embodiments of the invention.

FIG. 9 shows polarization data for as-spun fiber electrodes (black) and re-dispersed fiber electrodes (red) at 100% (filled) and 40% (unfilled) relative humidity, according to embodiments of the invention. Data were collected at 80° C., 200 kPa_{abs}, and 125/500 sccm of H₂/air at the anode and cathode, respectively.

FIG. 10 shows a top-down scanning electron microscope (SEM) image of an as-spun particle/polymer fiber mat, according to embodiments of the invention, where the fibers are composed of Pt/C, perfluorosulfonic acid, and poly(acrylic acid).

FIG. 11. shows the particle/polymer fibers of FIG. 10 in an ink after dispersing such fibers in an ethanol/water solvent, according to embodiments of the invention. Such an ink is suitable for preparing an electrode by an ink coating or spraying method.

FIG. 12 shows a top-down scanning electron microscope image of an as-spun fiber mat, according to embodiments of the invention, where the particle/polymer fibers are composed of Pt/C, perfluorosulfonic acid, and poly(ethylene oxide).

FIG. 13 shows a top-down scanning electron microscope image of a fiber mat electrode that was prepared from an ink with pre-formed fibers, according to embodiments of the invention. The fibers in the ink were composed of the same fiber shown in FIG. 12, i.e., Pt/C, perfluorosulfonic acid, and poly(ethylene oxide). The ink was deposited onto a carbon paper gas diffusion layer (GDL) by air-brush spraying. This figure shows that the pre-formed fibers are retained during ink preparation and the spraying of ink onto a GDL.

FIG. 14 shows H₂/air fuel cell polarization data for a membrane-electrode-assembly including a cathode that was made by spray-coating an ink containing solvent and pre-formed Pt/C/Nafion®/PAA fibers and a powder/binder sprayed anode, according to embodiments of the invention. Fuel cell data were collected at 100% relative humidity, 80° C., 200 kPa_{abs}, and 125/500 sccm of H₂/air at the anode and cathode, respectively.

FIG. 15 shows H₂/air fuel cell polarization data for a membrane-electrode-assembly, according to embodiments of the invention, where the cathode was made by spray-coating an ink containing solvent and pre-formed Pt/C/Nafion®/PEO fibers. Fuel cell data were collected at 100% relative humidity, 80° C., 200 kPa_{abs}, and 125/500 sccm of H₂/air at the anode and cathode, respectively.

FIG. 16 shows H₂/air fuel cell polarization data for a membrane-electrode-assembly, according to embodiments of the invention, where the cathode was made by spray-coating an ink that contains solvent, pre-formed Pt/C/Nafion®/PAA fibers, dispersed fluorinated ethylene propylene (FEP) polymer, and surfactant. Fuel cell data was collected at 100% relative humidity, 80° C., 200 kPa_{abs}, and 125/500 sccm of H₂/air at the anode and cathode, respectively.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this disclosure, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used in this disclosure, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this disclosure, the phrase “at least one of A, B, and C” should be construed to mean a logical (A or B or C), using a non-exclusive logical OR. As used herein, the term “and/or” includes any and all combinations of one or more of the associated listed items.

Embodiments of the invention are illustrated in detail hereinafter with reference to accompanying drawings. The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

Conventionally, an ink for the preparation of an electrode of an electrochemical device such a fuel cell is composed of powder, a polymer binder and solvent. For a proton exchange membrane (PEM) fuel cell, the polymer binder is often a perfluorosulfonic acid (PFSA) ionomer and the catalyst is Pt/C particles. In the ink, the particles and binder are mixed with a liquid solvent (normally alcohol/water mixture). Electrodes are prepared by coating or spraying the ink onto a proton conducting membrane to make a catalyst-coated-membrane (CCM) or the ink is sprayed or coated onto a carbon paper or carbon cloth gas diffusion layer (GDL) to make a gas diffusion electrode (GDE). In all cases, the ink can be viewed as a dispersion of catalyst powder in a liquid composed of polymer binder and solvent. However, no one has yet reported on the use of pre-formed particle/polymer fibers in electrode inks that can be sprayed or coated on either an ion-conducting membrane to make a CCM or on a GDL or on some other electrically conductive substrate.

In light of the foregoing, one of the objectives of this invention is to develop electrode inks containing pre-formed fibers and fiber electrodes made with the inks for an electrochemical device. The ink contains one or more different types of fibers dispersed in a solvent, where at least one of the fiber types is a fiber containing one or more particle types and one or more polymer types, where at least one type of the particles in a particle/polymer fiber is electrochemically active particles. The electrodes are made by coating or spraying the ink on substrates. Here an electrochemically active particle is defined as a particle where an electrochemical reaction can occur. Such particles can also be referred to as catalyst or electrocatalyst particles. The solvent may also contain freely suspended particles such as ceria particles or a catalyst powder, such as Pt/C, or polymer droplets such as a dispersion of polytetrafluoroethylene (PTFE) or polyvinylidene fluoride (PVDF) or fluorinated ethylene propylene (FEP), with or without an added ionic or non-ionic surfactant. Solid particles freely suspended in the ink may also participate in the electrochemical reaction. The micron/submicron diameter fibers in the ink are created using an electrospinning method or a method of creating fibers that does not employ an electric field, such as centrifugal spinning or gas jet spinning. The inks can be formed into an electrode by various coating or spraying methods. Layered electrode morphologies can be created by sequentially coating different fiber-based inks, for example, by coating/spraying alternating layers of two or more inks. Gradient electrode morphologies can also be created using multiple inks of different composition which are simultaneously sprayed at continuously varying flowrates. The resulting electrodes can be used in flow batteries, fuel cells, electrochemical reactors, sensors or electrolyzers, and so on.

It is an object of this invention to provide an ink containing at least one type of pre-formed fibers dispersed in one or more solvents. The pre-formed fibers include at least one particle/polymer fiber, where the at least one fiber includes at least one type of electrochemically active particles and a binder of one or more polymers. It will be understood by those skilled in the art that one or more aspects of the invention can meet certain objectives, while one or more aspects can meet certain other objectives. Each objective may not apply equally, in all its respects, to every aspect of the invention. As such, the following objects can be viewed in the alternative with respect to any one aspect of the invention.

It is another object of the invention to provide an ink containing one type of particle/polymer (binder) fibers, where the one type of fibers contains one type of electrochemically active particles and a binder of one or more polymers.

It is yet another object of the invention to provide an ink containing multiple different particle/polymer fibers, where the fibers differ by: (a) the type of particle, (b) the type of binder, (c) the binder/catalyst ratio, (d) intra-fiber porosity, (e) fiber diameter, (f) particle loading.

It is a further object of the invention to provide an ink containing one type of particle/polymer fibers, where the one type of fibers contains two or more different types of particles and/or two or more different binder polymers.

It is yet a further object of the invention to provide an ink containing two or more different fibers types, where at least one of which contains electrochemically active particles and a binder composed of one or more polymers, wherein at least one of the polymer binders is ionically conductive.

It is one object of the invention to provide an ink containing one or more particle/polymer fibers, where the fibers are mixed with a solvent that contains a surfactant and/or a polymer dispersant

It is another object of the invention to provide an ink containing one or more particle/polymer fibers, where the particles in at least one of the fibers is chosen from the group: a platinum group metal (PGM) on an support (e.g., Pt on carbon), PGM-free particles such an Fe—N—C particles, Ir, IrO₂, precious metal alloy catalysts on a support such as PtCo/C or PtNi/C, PGM black catalysts with no support such as Pt-black, Pd-black, Pd-black alloys and Pt-black alloys, carbon and graphite powders, detonation diamond powder, core-shell and shape controlled catalyst particles, catalysts for oxygen reduction in alkaline media, including Ag and Ni or combinations thereof.

Examples of the inks contain, but are not limited to, two or more different types of fibers.

In some embodiments, one type of fibers contains Pt/C and/or Pt-alloy/C particles with a charged polymer binder, such as a perfluorosulfonic acid (PFSA) binder, optionally with a second polymer like polyacrylic acid (PAA), polyethylene oxide (PEO), polyvinylpyrrolidone (PVP), or polyvinylidene fluoride (PVDF), and another type of fibers contains an uncharged polymer fiber, such as PVDF, polysulfone, polyamidimide, where the uncharged fibers contain ceria particles.

In some embodiments, one type of fibers contains an oxygen reduction reaction catalyst, such as Pt-black, Pt/C and/or Pt-alloy/C with a charged polymer binder, such as a perfluorosulfonic acid (PFSA) binder, optionally with a fiber spinning carrier polymer, and another type of fibers contains an oxygen evolution catalyst such as Ir or IrO₂ in a charged binder such as a perfluorosulfonic acid or an uncharged polymer binder, optionally with a fiber spinning carrier polymer like PAA, PEO, PVP, or PVDF.

In some embodiments, one type of fibers contains Pt/C and/or Pt-alloy/C particles and a charged polymer binder, such as a perfluorosulfonic acid binder, optionally with a fiber spinning carrier polymer such as PAA, PEO, or PVP, and another type of fibers contains Pt/C and/or Pt-alloy/C particles and a binder which is a mixture of PVDF or a copolymer thereof and a charged polymer such as PFSA.

In some embodiments, one type of fibers contains Pt/C and/or Pt-alloy/C particles and a charged polymer binder, such as a perfluorosulfonic acid binder, optionally with a fiber spinning carrier polymer such as PAA, PEO, PVP, or PVDF, and another type of fibers contains ceria particles and hydrocarbon or fluoropolymer binder with or without fixed cation exchange sites.

In any of the above embodiments, the ink may also contain a dispersion of polymer micelles and/or a charged or uncharged surfactant.

The fibers can be in any fiber morphology, such as core-shell fibers, solid fibers, and hollow fibers, with a uniform distribution of particles and binder in the radial direction, or a non-uniform distribution of particles and/or binder in the radial direction.

In some embodiments, the composition of the fibers includes catalysts powders. The catalysts powders can be a platinum group metal (PGM) on an support (e.g., Pt on carbon), PGM-free particles such an Fe—N—C particles, Ir, IrO₂, precious metal alloy catalysts on a support such as PtCo/C or PtNi/C, PGM black catalysts with no support such as Pt-black, Pd-black, Pd-alloys and Pt-alloys, carbon and graphite powders, detonation diamond powder, core-shell and shape controlled catalyst particles, catalysts for oxygen reduction in alkaline media, including Ag and Ni, or combinations thereof.

In some embodiments, the fiber composition also includes a binder. The binder may be a cation exchange polymer such as a PFSA polymer with an equivalent weight in the approximate range of 725-1100 or a hydrocarbon polymer with proton exchange ion-exchange groups. The binder may be an anion-exchange (hydroxide ion-exchange) polymer. The binder may also be mixtures of an uncharged and charge polymer, where the charged polymer is either an anion-exchange polymer or a cation-exchange polymer and where the uncharged polymer is either a hydrocarbon polymer or a partially/fully fluorinated polymer. The binder may further be mixtures of two or more cation-exchange polymers or mixtures of two or more anion exchange polymers.

In some embodiments, the fiber composition may further include a carrier polymer for electrospinning. The carrier polymer can be PAA, PEO, PVP, PVDF, poly(vinyl alcohol) (PVA), either as a single carried polymer or mixtures of two or more carrier polymers.

In some embodiments, the fiber composition may also include surfactants and polymer dispersants, such as fluorinated ethylene propylene (FEP), PVDF, polytetrafluoroethylene (PTFE) dispersed in water or in an alcohol/water solvent with added surfactants, and/or ionic, zwitterionic, or uncharged surfactants.

The fibers can be made or fabricated by, but not limited to, (1) electrospinning with spinnerets containing one or more needles or by needleless equipment, (2) fiber spinning methods that do not rely on an electric field: e.g., centrifugal spinning, and/or gas jet spinning, (3) foam electrospinning, and/or (4) hybrid methods involving fiber spinning methods with an applied electric field.

Moreover, it also is an object of the invention to provide an electrode made with a single ink with a uniform ink distribution in the electrode thickness direction.

It also is an object of the invention to provide an electrode made with multiple different inks, each of which contains pre-formed fibers, where the ink deposition method results in a layered morphology in the electrode thickness direction, and the layers differ in thickness and/or fiber morphology and/or fiber composition.

It is also an objective of the invention to provide an electrode with multiple layers of two or more different compositions, where the sequence of two or more differing layers is repeated in the electrode thickness direction.

It also is an object of the invention to provide an electrode made with two or more inks, where such inks are sequentially deposited in the electrode thickness direction.

It also is an object of the invention to provide an electrode made with two or more inks, where such inks are simultaneously deposited during electrode preparation.

It also is an object of the invention to provide an electrode made with two or more different inks, where such inks are simultaneously deposited during electrode preparation, and the flow rate of ink deposition for each ink is continuously varied to create a continuous gradient electrode composition.

It also is an object of the invention to provide an electrode made with two or more inks, where there is a gradient composition in the fiber composition in the planar electrode direction (parallel to the electrode thickness) and/or in the electrode thickness direction.

It also is an object of the invention to provide any of the different compositions of the inks disclosed above, where there is variation in fiber composition in the direction perpendicular and/or parallel to the electrode thickness.

In some embodiments, the electrodes disclosed above can be made by any coating methods, such as slot-die coating, Meyer rod coating, gravure and micro gravure coating methods and modifications thereof. The coating methods include, but are not limited to, gravure coating, reverse roll coating, knife-over-roll coating “gap coating”, metering rod (Meyer rod) coating, slot die (slot, extrusion) coating, immersion (dip) coating, curtain coating, and air knife coating.

In some embodiments, the electrodes can also be made by spraying methods, including air-brush spraying, electrospraying, ultrasonic spraying, and their modifications.

In some embodiments, the electrodes can also be made by preparing catalyst coated membranes (CCMs) where the ink coats the membrane, for the cathode and/or anode.

In some embodiments, the electrodes can also be made by preparing GDEs, where the ink is coated on carbon paper or carbon cloth or on some other GDL, where such GDEs are prepared for the cathode and/or anode.

In some embodiments, the electrodes can also be made by preparing electrodes where one electrode is coated on the ion-conducting membrane and one electrode is coated on a gas diffusion layer.

The electrodes disclosed above can find applications in, but not limited to, PEM fuel cells, alkaline (hydroxide exchange) fuel cells, alcohol fuel cells, such as the direct methanol fuel cell, reversible/regenerative fuel cells such as H₂/Br₂ or H₂/O₂ regenerative fuel cells, redox flow batteries such as the vanadium redox flow battery and acid/base redox flow batteries, electrolyzers, such as those use to make hydrogen from water, electrochemical reactors for organic synthesis, inorganic synthesis, and CO₂ reduction, primary and secondary batteries (do not include Li-ion batteries), supercapacitors/capacitors, and the likes.

The inks described herein, which contain suspended fibers composed of particles and polymer binder, have not been reported in the open literature and do not resemble any inks that have been used previously to make electrodes for fuel cell or any other electrochemical device. Papers and patents on nanofiber electrodes for fuel cells and have been published (see, for example, Brodt et al., “Fabrication, In-Situ Performance, and Durability of Nanofiber Fuel Cell Electrodes”, Journal of the Electrochemical Society, 162, F84-F91 (2015)), but such electrodes differ from the subject matter of this invention in a number of different ways: (1) an electrospun fiber mat was used directly as the electrode material; the fibers were spun directly onto a membrane or GDL or they were transferred from an spinning device to a membrane or GDL; the fibers were not used to make an ink, (2) there was no ink coating step in preparing a CCM or GDE for fuel cell membrane-electrode-assemblies, (3) the prior fiber electrode work did not describe electrodes composed of multiple fiber types in a fuel cell, electrolyzer, electrochemical reactor, or redox flow battery electrode, and (4) the prior work did not discuss the use of layered electrode structures. Thus there is a substantial difference in the subject matter of this patent versus prior art dealing with nanofiber mat electrodes.

The following exemplary aspects further illustrate the invention but should not be construed as in any way limiting the scope of the invention.

Aspects of the invention relate to composite electrodes and electrochemical devices having the same. The composite electrodes are multi-fiber electrodes having two or more different fibers in the electrodes, or one or more fibers and one or more different sprayed/electrosprayed droplets/particles in the electrodes, where the composition of each particle/polymer fiber is different, and/or the composition of the one or more fibers and the one or more sprayed droplets is different. Sprayed material can be: (1) particles only, (2) polymer particles that may be suspended in a solvent as micelles/droplets, or (3) droplets containing polymer and particles, with or without solvent. Although not explicitly stated in all of the examples described below, the fiber component(s) of a composite electrode is made by coating or spraying an ink that contains pre-formed fibers.

Exemplary applications of the composite electrodes are as electrodes (anode and/or cathode) in, but are not limited to, batteries (primary, secondary, and redox flow batteries), proton exchange membrane and alkaline fuel cells, electrolyzers, electrochemical reactors including those for inorganic and organic synthesis and those used for CO₂ reduction, sensors, capacitors, and other electrochemical devices. Such electrodes are composed of (1) a mixture of two or more distinctly different particle/polymer fibers (hereinafter identified as a dual fiber mat for the case where there are two distinct fibers), and/or (2) a fiber mat with sprayed/electrosprayed particles on and between the fibers (hereinafter called an electrospun/electrosprayed mat), and/or (3) an electrode made by a coating method wherein the ink contains one or more pre-formed fibers and one or more suspended/dispersed droplets or solid particles where said droplets are a dispersion of polymer droplets/micelles or the droplets contain both solid particles and polymer. In a dual fiber mat, the two types of fibers may differ by: (a) using different polymer binders with the same particles, (b) using different particles and the same polymer binder, or (c) using different particles and polymer binders for the two fibers. The method and materials can be extended to fiber mats electrodes containing three or more different fibers, fiber mats containing one type of particle/polymer fiber and two or more different types of sprayed droplets, and fiber mats containing two or more different fibers and two or more different sprayed droplets.

Another aspects of the invention also include (i) a composite electrode where one of the electrospun fibers and/or one of the types of droplets contains no particles and (ii) a composite electrode composed of multiple particle/polymer droplets and no fibers.

In addition, it should be appreciated that the general spun/sprayed fiber mat configuration can also be used in non-electrochemical applications.

In one aspect of the invention, the composite electrode comprises two or more types of fibers forming a fiber network, comprising at least a first type of fibers and a second type of fibers, where the first type of fibers comprises a first polymer and a first type of particles; and the second type of fibers comprises a second polymer and a second type of particles; and the second polymer is same as or different from the first polymer, and the second type of particles are same as or different from the first type of particles.

In certain embodiments, each of the first polymer and the second polymer comprises polyacrylic acid (PAA), polyamide-imide (PAI), polyvinylidene fluoride (PVDF), polyethylene oxide (PEO), or polyacrylonitrile (PAN).

In certain embodiments, each of the first type of particles and the second type of particles comprises electrochemically active particles, or electrically conductive particles.

In certain embodiments, the electrochemically active particles comprise silicon (Si) particles, Si nanoparticles, Si nanowires, Si-carbon particles, titania particles, and/or precious metal (such as Pt, Ir, Ru Pd, Ni, Ag), metal alloys (such as PtNi or PtCo), or non-precious metal catalysts (such those with Fe—N—C active sites) on a conductive support like carbon or on a non-conductive support like titania or alumina.

The electrically conductive particles comprise carbon particles, graphite particles, carbon black particles, carbon nanotubes, carbon fibers, or a mixture thereof.

In certain embodiments, the first type of fibers is formed by electrospinning a first solution containing the first polymer and the first type of particles; and the second type of fibers is formed by electrospinning a second solution containing another the second polymer and the second type of particles.

In one exemplary embodiment disclosed in EXAMPLE 1 below, the first type of fibers comprises electrospun Si/PAA fibers, and the second type of fibers comprises electrospun C/PAN fibers. The ratio of the electrospun Si/PAA fibers to the electrospun C/PAN fibers is about 70:30 wt. %. The Si:PPA ratio of the electrospun Si/PAA fibers is about 50:50 wt. %, and a C:PAN ratio of the electrospun C/PAN fibers is about 63:37 wt. %.

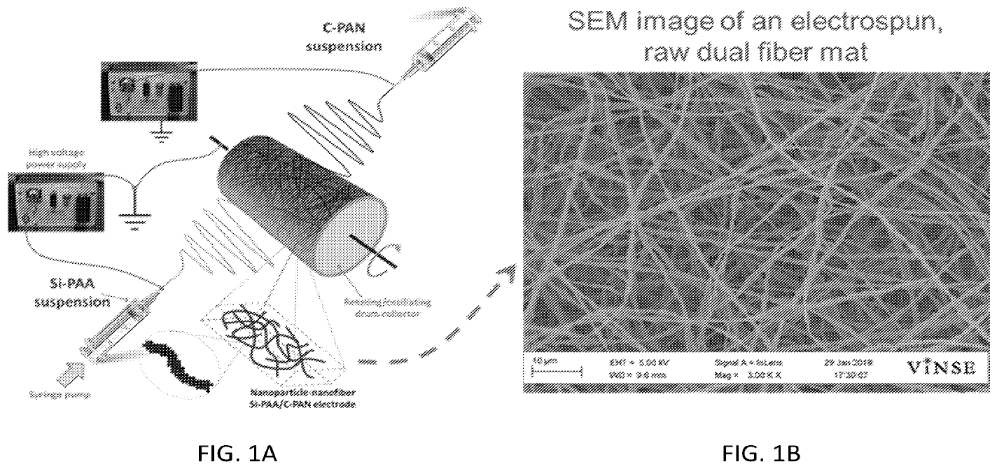

In one exemplary embodiment shown in FIG. 1A, the first type of fibers and the second type of fibers are simultaneously electrospun/coated (i.e., co-electrospun) on a drum collector or a substrate. In another embodiment, the first type of fibers and the second type of fibers are sequentially electrospun/coated onto one another on a drum collector or a substrate, so that the composite electrode comprises a layered structure with each layer thickness and porosity fixed or variable.

In another aspect of the invention, the composite electrode comprises at least one type of fibers forming a fiber network; and at least one type of droplets interspersed in the fiber network, where said at least one type of fibers comprises a first polymer and a first type of particles; and wherein said at least one type of droplets comprises a second types of particles.

In certain embodiments, each of the first type of particles and the second type of particles comprises electrochemically active particles, or electrically conductive particles.

In certain embodiments, the electrochemically active particles comprise silicon (Si) particles, Si nanoparticles, Si nanowires, Si-carbon particles, titania particles, and/or precious metal or non-precious metal catalysts particles on non-conductive supports like titania or alumina, and the electrically conductive particles comprise carbon particles, graphite particles, carbon black particles, carbon nanotubes, carbon fibers, or a mixture thereof.

In certain embodiments, said at least one type of droplets further comprises a second polymer.

In certain embodiments, each of the first polymer and the second polymer comprises PAA, PAI, PVDF, or PAN.

In certain embodiments, said at least one type of fibers is formed by electrospinning a first solution containing the first polymer and the first type of particles, and wherein said at least one type of droplets is formed by spraying/electrospraying a second solution the second polymer and the second type of particles.

In one exemplary embodiment disclosed in EXAMPLE 2 below, said at least one type of fibers comprises electrospun Si/PAA fibers, and said at least one type of droplets comprises sprayed/electrosprayed C/PVDF droplets, or sprayed/electrosprayed C/PAI droplets. The Si:PAA ratio of the electrospun Si/PAA fibers is about 60:40 wt. %, and a C:PVDF ratio of the C/PVDF sprayed/electrosprayed droplets is about 83:17 wt. %. The composite electrode has about 20 wt. % carbon, about 45 wt. % silicon, about 35 wt. % binder.

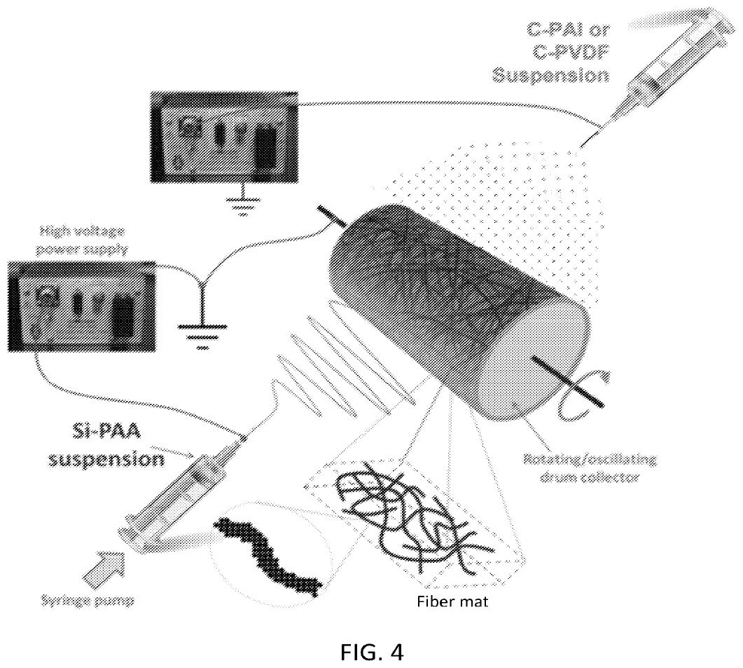

In one exemplary embodiment shown in FIG. 4, the one type of fibers and the one type of droplets are simultaneously electrospun and electrosprayed on a drum collector or a substrate. In another embodiment, the one type of fibers and the one type of droplets are sequentially electrospun and electrosprayed onto one another on a drum collector or a substrate, so that the composite electrode comprises a layered structure with layer thickness and porosity fixed or variable. A similar electrode structure can be made by simultaneously spraying two inks: one ink with Si/PAA fibers and a second ink with C/PAI or C/PVDF.

In yet another aspect of the invention, the composite electrode is a multi-fiber electrode formed by coating an electrode ink comprising fibers and a solvent on a membrane/separator or on a conductive substrate to form the multi-fiber electrode after solvent removal, wherein the fibers are pre-formed before preparation of the electrode ink via a fiber spinning process; and the fibers comprises one or more polymers, and/or one or more types of particles.

In certain embodiments, the electrode ink further comprises the pre-formed fibers and a polymeric binder dispersed in the solvent.

In certain embodiments, the electrode ink comprises the pre-formed fibers and micellar droplets (particles) of a water-insoluble polymer dispersed in the solvent, wherein the solvent is a water/alcohol solvent.

In certain embodiments, the water-insoluble polymer comprises a perfluorosulfonic acid (PFSA) polymer or a hydrocarbon polymer with negative fixed charged sites.

In certain embodiments, said one or more types of particles comprise catalyst particles or particles of an electrochemically active material, optionally mixed with a polymeric binder.

In certain embodiments, said one or more types of particles comprise micellar polymer droplets.

In certain embodiments, the fiber spinning process comprises electrospinning with needle orifices, needless electrospinning, centrifugal spinning, or gas jet fiber spinning.

In certain embodiments, said coating the electrode ink is performed by spraying coating, electrospraying, ultrasonic spraying, or slot-die coating.

In certain embodiments, the pre-formed fibers in the electrode ink comprise only one type of fibers.

In certain embodiments, the pre-formed fibers in the electrode ink comprise two or more different types of fibers, wherein each type of the fibers differs in the type/amount of particles, and/or the type/amount of a polymer binder, and/or the fiber morphology including fiber diameter and internal fiber porosity.

In certain embodiments, the ink for coating contains one or more pre-formed fibers and one or more different types of dispersed droplets, where the droplets are composed of particles, polymer, or a mixture of particles and polymer.

In certain embodiments, the composite electrode is a layered electrode structure having multiple layers of composite fiber electrodes deposited onto one another.

In certain embodiments, the composite electrode is a layered or gradient-composition electrode structure formed by coating multiple different fiber-containing inks onto one another sequentially.

In certain embodiments, each of said multiple different fiber-containing inks differs in fiber type/structure including fiber diameter and porosity, fiber composition, and binder type and amount.

In certain embodiments, thickness and porosity of each layer are fixed or variable.

Certain aspects of the invention also disclose the composite electrode comprising two or more types of fibers, and one or multiple different types of particle/polymer fibers and one or more different sprayed droplets. Each type of the fibers comprises a different type/amount of particles and/or a different type/amount of polymer binder. The multiple fibers and multiple sprayed droplets differ in the type/amount of particles and the type/amount of polymer.

In certain embodiments, the fibers and/or droplets are submicron in diameter.

In certain embodiments, the composite electrode includes Si particles, Si nanoparticles, Si nanowires, Si-carbon particles, titania particles, and/or precious metal or non-precious metal catalysts particles on non-conductive supports like titania or alumina as an electrochemically active material and a carbon material as an electrically conductive material.

In certain embodiments, the Si particles, Si nanoparticles, Si nanowires, Si-carbon particles, titania particles, and/or precious metal or non-precious metal catalysts particles on a conductive support like carbon or on a non-conductive support like titania or alumina are contained in a nanofiber network.

In certain embodiments, the electrically conductive material is carbon particles, graphite particles, carbon black particles, carbon nanotubes, or mixtures thereof.

In certain embodiments, the carbon particles, graphite particles, carbon black particles, carbon nanotubes, carbon fibers, or mixtures thereof are contained in a nanofiber network.

In certain embodiments, the carbon particles, graphite particles, carbon black particles, carbon nanotubes, carbon fibers, or mixtures thereof are contained in droplets which coat the Si fibers and/or distribute/located between the Si fibers.

In certain embodiments, the composite electrode includes electrospun Si/PAA fibers and electrosprayed C/PAI droplets.

In certain embodiments, the composite electrode includes electrospun Si/PAA fibers and electrosprayed C/PVDF droplets.

In certain embodiments, the composite electrode includes electrospun Si/PAA fibers and electrospun C/PAI fibers.

In certain embodiments, the sprayed droplets of electrically conductive material have no binder.

In certain embodiments, a multi-fiber electrode is prepared using an electrode ink containing fibers and solvent (with/without a binder) where the fibers are pre-formed before ink preparation via needle or needleless electrospinning and where the fibers are composed of only polymer (one or more polymers), or one or more types of catalyst particles or particles of an electrochemically active material with a polymeric binder, where the binder may be composed of one or more polymers. In this embodiment, the procedure for fabricating such a multi-fiber electrode is as follows: (1) separately create fiber mats by spinning polymer fibers or particle/polymer fibers via electrospinning or some other fiber spinning process such as centrifugal spinning, (2) combine/mix the fibers in a solvent at a given solvent (e.g., water or a mixture of water and alcohol), with or without a polymer binder (i.e., optionally add a polymeric binder to the catalyst/solvent suspension), and (3) use a coating method (e.g., spraying coating, electrospraying, ultrasonic spraying, or slot-die coating) to coat the ink on a membrane/separator or on a conductive substrate to create (after solvent removal) a multi-fiber electrode. In some cases there may only be one type of fibers in the ink, in other applications of this technology the ink may contain two or more different types of fibers, where the fibers differ in the type/amount of particles and/or the type/amount of polymer binder and/or the fiber morphology (e.g., fiber diameter, internal fiber porosity, etc.).

In certain embodiments, multiple layers of composite fiber electrodes are deposited onto one another to create a layered electrode structure. In another embodiment of this invention, multiple different fiber-containing inks are coated onto one another sequentially to give a layered or gradient-composition electrode structure. For these layered constructs, the fiber type/structure (fiber diameter and porosity), fiber composition, and binder type and amount will vary in each layer because different fiber-containing inks are used for each layer. Additionally, the thickness and porosity of each layer can be varied.

In certain embodiments, the ink for coating contains dispersion of a perfluorosulfonic acid polymer and pre-formed fibers, where said fibers contain a precious metal catalyst powder (such as Pt/C) or a precious metal alloy catalyst powder (such as PtNi/C or PtCo/C) and a polymer binder.

As a particular example, the composite electrode is composed of fibers containing electrochemically active particles in a polymer binder, where the particles have minimal electrical conductivity. Electron flow (electrical conductivity) throughout the fiber mat is created by: (1) co-electrospinning (via dual fiber electrospinning) conductive particles in a polymer binder, or (2) electrospraying electrically conductive particles while electrospinning fibers of electrochemically active particles. For a lithium-ion battery anode, one can electrospin Si nanoparticles or nanowires with a suitable binder such as poly(acrylic acid). One can then disperse these fibers in an ink and then either add carbon black power and polymer binder (e.g., PVDF or PAN) to the ink or spray a mixture of carbon black power and binder while spraying the ink with Si/binder fibers. Alternatively on can deposit an ink containing pre-formed Si/binder fiber and then spray an ink containing carbon black and binder.

In certain embodiments, the fibers in the inks used to make composite electrodes can be made using an electric field (electrospinning and electrospraying). Fiber mats can also be made by spinning and spraying methods that do not involve an electric filed, such as centrifugal fiber spinning and gas jet fiber spinning and air-brush spraying The fiber mats can be produced via electrospinning and electrospraying using single or multiple needle equipment, by needless electrospinning, or by a combination of needle and needleless electrospinning. Additionally, the electrospraying step for electrospun/electrosprayed fiber mats can be prepared by any kind of spraying methods that result in deposited droplets smaller than about 1-2 microns.

In certain embodiments, the composite electrode is a silicon anode for lithium ion batteries, where the Si and electrically conductive material (carbon or graphite) are separated in the electrode, with the Si nanoparticles or nanowires are in the fibers and the carbon is either in a separate fiber or in sprayed droplets between the fibers. In one exemplary example, the Si anode underwent 1,000 charge/discharge cycles and was still working well. That would be at least 3 years of charge/discharge operation for an electric vehicle battery.

It should be appreciated that such composite electrodes can be used as the anode and/or cathode in other battery systems.

In certain embodiments, an electrode for an electrochemical device (fuel cell, battery, supercapacitor, or electrolyzer) includes the electrochemically active material and the electrically conductive material are separated, either as two distinct electrospun fibers, or as fibers and sprayed droplets, where the droplets coat the fibers, and/or are deposited between the fibers.

As another exemplary example, a fuel cell electrode is described in EXAMPLE 3 below. In this example, the term “particle” refers to a micellar polymer droplet dispersed in a solvent. The fuel cell electrode contains fibers and polymer particles. The electrode is prepared from an ink containing one fiber type, where polymer droplets (particles) are dispersed in the ink. The electrode is a composite structure, with pre-formed fibers mixed and micellar droplets (particles) of a perfluorosulfonic acid polymer or some other water-insoluble polymer dispersed in a water/alcohol solvent.

In other aspects of the invention, the ink contains pre-formed fibers suspended in a solvent. The ink may contain one fiber type, where the fibers may contain one or more different types of particles, at least one of which is electrochemically active, and one or more different polymers. The ink may contain two or more different fiber types, composed of particles and polymer or polymer without particles, where at least one of the multiple fiber types contains one or more particles, where at least one particle type is an electrochemically active particle. The ink may also contain one or more different types of dispersed particles, one or more soluble polymers, one or more dispersed (insoluble) polymers and other components such as one or more surfactants.

The inks are used to fabricate electrodes, where such electrodes are used in an electrochemical device. Electrodes are made using a coating or spraying process. Electrodes are made using one ink or multiple inks of different composition or where multiple different fibers are contained in a single ink. Multiple inks are used to make layered and gradient composition electrodes. The electrodes are used in electrochemical devices,

Exemplary applications of the inks containing pre-formed fibers composite electrodes are as electrodes (anode and/or cathode) in, but are not limited to proton exchange membrane and alkaline (hydroxide exchange) fuel cells, electrolyzers, regenerative fuel cells, electrochemical reactors including those for inorganic and organic synthesis and those used for CO₂ reduction, sensors, capacitors, flow batteries, including redox flow batteries, and other electrochemical devices. Such electrodes are composed of (1) a single type of particle/polymer fiber, (2) a mixture of two or more distinctly different fibers, at least one of which is a particle/polymer fiber type, (3) an electrode made by a coating or spraying method wherein the ink contains one or more pre-formed fibers and one or more suspended/dispersed droplets or solid particles where said droplets are polymer droplets/micelles or the droplets contain both solid particles and polymer, and (4) an electrode made by a coating or spraying method, wherein the ink described by (3) may also contain one or more surfactants. A particle/polymer fiber will contain one or more different particles and one or more different polymers. In an ink with two or more different fiber types, the fibers may differ by: (a) using different polymer binders with the same particles, (b) using different particles and the same polymer binder, (c) using different particles and different polymer binders, (d) using the same particle and binder but the particle/binder weight ratio is different, or (e) in some other structure characteristic such as fiber diameter and porosity. The method and materials described below can be extended to fiber mats electrodes containing two or more different fibers, fiber mats containing one type of particle/polymer fiber and two or more different types of sprayed droplets, and fiber mats containing two or more different fibers and two or more different sprayed droplets. In all multiple fiber inks, at least one of the pre-formed fibers contains one or more electrochemically active particles (used interchangeably herein with the term electrocatalyst) and one or more polymers. Inks with pre-formed fibers can be deposited onto an electrically conductive substrate, such as carbon paper or a titanium mesh, or onto an ion-conducting membrane. Spraying or coating methods can be used to deposit the inks. Multi-layer electrodes can be made where the layers differ in ink composition and/or fiber composition or morphology. Such electrodes can have two or more alternating layers (an A-B-A-B or A-B-C-A-B-C layered structure, for example) or there can be a near-continuous gradient variation in fiber electrode composition in the electrode thickness and/or in-plane electrode direction.

In one aspect, the invention relates to an electrode ink comprising a dispersion of fibers in at least one solvent, wherein said fibers have one or more fiber types, wherein at least one type of said fibers comprises at least one catalyst for an electrochemical reaction and at least one binder polymer.

In certain embodiments, the at least one catalyst comprises electrochemically active particles, or electrically conductive particles that have no/minimal electrochemical activity.

In certain embodiments, the at least one catalyst comprises a catalyst composed of a metal or alloy on a catalyst support, or a metal or alloy with no support.

In certain embodiments, the at least one catalyst comprises Pt, Pd, Rh, Ru, Ir, IrO₂, Au, Ag, Ni, Zn, Ti, Mo, Co, Fe, W, Cu, Cr, Ta, or a mixture or blend or alloy thereof.

In certain embodiments, the at least one catalyst comprises one or more of a platinum-group-metal (PGM) on the catalyst support; PGM-free particles including Fe—N—C particles, Ir, IrO₂, precious metal alloy catalysts on the catalyst support including PtCo/C or PtNi/C; and PGM black catalysts with no support including Pt-black, Pd-black, Pd-black alloys and Pt-black alloys, carbon and graphite powders, detonation diamond powder, core-shell and shape controlled catalyst particles, catalysts for oxygen reduction in alkaline media including Ag and Ni.

In certain embodiments, the catalyst support comprises carbon, graphite, or oxides or carbides of metals including Si, Mo, Ti, or Al.

In certain embodiments, the at least one binder polymer is an ionomer comprising uncharged repeat units and repeat units with charged/ionizable repeating units.

In certain embodiments, the at least one solvent comprises water, or a water/organic mixture.

In certain embodiments, an organic component of the water/organic mixture is an alcohol.

In certain embodiments, the alcohol is ethanol.

In certain embodiments, the at least one solvent further comprises a dispersion of at least one fluorinated polymer.

In certain embodiments, the at least one fluorinated polymer is polytetrafluoroethylene (PTFE), polyvinylidene fluoride (PVDF), or fluorinated ethylene propylene (FEP).

In certain embodiments, the at least one solvent further comprises one or more ionic or nonionic surfactants, and/or one or more polymer dispersants.

In certain embodiments, the at least one solvent further comprises one or more particles.

In certain embodiments, the one or more particles are ceria particle and/or one or more electrocatalyst particles.

In certain embodiments, the at least one catalyst comprises two or more different catalysts, and the at least one binder polymer comprises two or more different polymers.

In certain embodiments, the at least one type of said fibers further comprises a carrier polymer.

In certain embodiments, the carrier polymer comprises polyethylene oxide (PEO), poly(acrylic acid) (PAA), polyvinyl alcohol (PVA), polyvinylpyrrolidone (PVP), polyethylene glycol (PEG), or a mixture thereof.

In certain embodiments, the at least one catalyst comprises Pt/C, Pt/Co/C, PtNi/C, or ceria particles and the at least one binder polymer comprises perfluorosulfonic acid.

In certain embodiments, at least another type of said fibers comprises fibers containing Ir or IrO₂, or ceria particles in a binder of one or more polymers.

In another aspect, the invention relates to an electrode, being fabricated using the ink of any one of the above disclosed inks.

In certain embodiments, the electrode is fabricated with a single ink with a uniform ink distribution in the electrode thickness direction.

In yet another aspect, the invention relates to an electrode, being fabricated using multiple different inks, each ink has a formulation according to any one or more of the above disclosed inks. At least one type of said fibers in each ink contains one or more catalyst and one or more polymers.

In certain embodiments, the electrode comprises multiple layers, wherein each layer is made by a respective ink, wherein said inks differ in fiber content, fiber diameter and porosity, fiber composition, solvent, type and the presence or absence of dispersed polymer droplets and/or surfactant.

In certain embodiments, the electrode is fabricated by a spraying, electrospraying, ultrasonically spraying, or coating process.

In certain embodiments, the coating process is a die-slot coating process, or a process that utilizes Meyer rods or similar devices.

In certain embodiments, the electrode is an electrospun fibrous mat electrode comprising a catalyst powder, an ionomer, a dispersed uncharged polymer and a carrier polymer.

In certain embodiments, the electrode is fabricated with two or more inks, wherein the two or more inks are sequentially deposited in the electrode thickness direction.

In certain embodiments, the electrode is fabricated with two or more inks, wherein the two or more inks are simultaneously deposited during electrode fabrication.

In certain embodiments, the electrode is fabricated with two or more different inks, wherein the two or more inks are simultaneously deposited during electrode fabrication, wherein the flow rate of ink deposition for each ink is continuously varied to create a continuous gradient electrode composition.

In certain embodiments, the electrode is fabricated from two or more inks, wherein a gradient composition exists in the fiber composition in the planar electrode direction and/or in the electrode thickness direction.

In certain embodiments, the electrode is fabricated from two or more inks, wherein a variation exists in fiber composition in the direction perpendicular and/or parallel to the electrode thickness.

In one aspect of the invention, the composite electrode is a single fiber mat or a mat with multiple different fibers formed by a coating or spraying process, where the ink that is used during the coating or spraying comprises fibers, a solvent, and optionally solid particles. The ink may also contain a soluble polymer, dispersed polymer droplets/micelles/particles, and/or one or more surfactants. The ink is deposited onto a membrane/separator or on a conductive substrate to form the electrode after solvent removal, wherein the fibers are pre-formed before preparation of the electrode ink via a fiber spinning process.

In one embodiment, the electrode ink comprises the pre-formed fibers and micellar droplets (particles) of a water-insoluble polymer dispersed in the solvent, wherein the solvent is a water or water/alcohol solvent.

In one embodiment, the water-insoluble polymer comprises a perfluorosulfonic acid (PFSA) polymer, a fluorinated polymer or a water insoluble hydrocarbon polymer, where the polymer is either uncharged or with negatively charged or positively charged ion-exchange groups.

In one embodiment, the ink contains fibers with two or more different particles and a polymer binder and/or two or more polymers.

In one embodiment, the ink contains two or more particle/polymer and polymer fibers, at least one of which is a particle/polymer fiber with electrochemically active particles.

In one embodiment, the fiber are made by a spinning process comprises electrospinning, centrifugal spinning, gas jet fiber spinning, or some other spinning method to make fibers of submicron diameter.

In one embodiment, said coating the electrode ink is performed by a coating method, including but not limited to gravure and micro gravure coating methods (and modifications thereof), reverse roll coating, knife-over-roll coating “gap coating”, metering rod (Meyer rod) coating, slot die (slot, extrusion) coating, immersion (dip) coating, curtain coating, and air knife coating.

In one embodiment, electrodes are fabricated by a spraying method, including air-brush spraying, electrospraying, ultrasonic spraying, and modified versions of each.

In one embodiment, the pre-formed fibers in the electrode ink comprise only one type of fibers.

In one embodiment, the pre-formed fibers contain one or more electrochemically active particles and one or more different polymers.

In one embodiment, the pre-formed fibers in the electrode ink comprise two or more different types of fibers, wherein each type of the fibers differs in the type/amount of particles, and/or the type/amount of a polymer binder, and/or the fiber morphology including fiber diameter and internal fiber porosity.

In one embodiment, the fibers in the ink contain a charged fluoropolymer or a charged hydrocarbon polymer.

In one embodiment, the fibers in the ink contain perfluorosulfonic acid.

In one embodiment, the composite electrode has a layered electrode structure having multiple layers of composite fiber electrodes of different composition and/or fiber morphology.

In one embodiment, the composite electrode has a gradient-composition structure, formed using multiple inks of different composition and/or fiber morphology.

In one embodiment, each of said multiple different fiber-containing inks differs in fiber type/structure including fiber diameter and porosity, fiber composition, binder type and amount and/or solvent type and amount.

In one embodiment, the thickness and porosity of each layer are fixed or variable.

In one embodiment, there are alternating layers of two or more different inks where at least one of the layers is made using an ink with pre-formed fibers.

In one embodiment, the ink(s) is coated or sprayed onto an ion-exchange membrane to make a catalyst-coated-membrane.

In one embodiment, the ink(s) is coated on an electrically conductive substrate, such as carbon paper, carbon cloth, or a metal mesh.

In certain aspects, the invention also relates to an electrochemical device comprising any one of fiber electrodes as recited above.

In one embodiment, the inks with pre-formed fibers are used to make the cathode and/or anode for a fuel cell.

In one embodiment the fuel cell is a proton-exchange membrane fuel cell or an alkaline (hydroxide exchange) fuel cell.

In certain aspects, the invention relates to such electrochemical devices as methanol/alcohol fuel cells, reversible/regenerative fuel cells such as H₂/Br₂ or H₂/O₂ regenerative fuel cells, flow batteries such as the vanadium redox flow battery, electrolyzers, such as those use to make hydrogen from water, electrochemical reactors, for organic synthesis, inorganic synthesis, and CO₂ reduction, and supercapacitors/capacitors.

In another aspect of the invention, the ink used to make an electrode comprises one type of pre-formed particle/polymer fibers that is dispersed in a solvent. The fibers contain one type of particle and two types of polymers. The ink is sprayed onto a carbon paper gas diffusion layer to make a gas diffusion electrode for a fuel cell. The two types of polymers comprise an ionically conducting polymer such as a perfluorosulfonic acid ionomer and a second polymer which may be PAA, PAI, PVDF, PEO, PVP, or polyvinyl alcohol (VA).

In certain embodiments, the water-insoluble polymer comprises a hydrocarbon polymer with either negative or positive fixed charged sites.

In certain embodiments, the water-insoluble polymer comprises a perfluorosulfonic acid (PFSA) polymer.

In certain embodiments, the water-insoluble polymer comprises an uncharged polymer.

In certain embodiments, the water-insoluble polymer is fluorinated ethylene propylene.

In certain embodiments, said one or more types of particles in the fibers comprise catalyst particles or particles of an electrochemically active material (also referred to as an electrocatalyst).

In certain embodiments, the fiber spinning process comprises electrospinning with one or more needle orifices, needless electrospinning, a combination of needle and needleless electrospinning, or a method that does not employ an electric field, such a centrifugal spinning, or gas jet fiber spinning.

In certain embodiments, said coating the electrode ink is performed by a spraying process such as air-brush spraying, electrospraying, ultrasonic spraying, or a coating process such as slot-die coating or Meyer rod coating.

In certain embodiments, the pre-formed fibers in the electrode ink comprise only one type of fibers.

In certain embodiments, the pre-formed fibers in the electrode ink comprise two or more different types of fibers, wherein each type of fibers differs in the type/amount of particles, and/or the type/amount of polymer binder, the particle/polymer weight ratio, and/or the fiber morphology including fiber diameter and internal fiber porosity.

In certain embodiments the one-type of fiber in the ink may contain two or more different types of particles and two or more different polymers.

Certain aspects of the invention also disclose an electrode comprising two or more different types of fibers, and one or more different polymer droplets in the solvent used to prepare the ink.

In certain embodiments, the fibers are submicron in diameter.

In certain embodiments, a multi-fiber electrode is prepared using an electrode ink containing two or more different types of fibers in a solvent where at least one fiber type contains electrochemically active particles (particles at which an electrochemical reaction occurs) and one or more polymers which act as a particle binder. The other types of fibers in the ink and in the electrode maybe composed of: (i) one or more polymers (no particles), (ii) one or more polymers and two or more types of electrochemically active catalyst particles, (iii) one or more polymers and one or more non-electrochemically active particles, or (iv) one or more polymers and one or electrochemically active and one or more non-active particles.

In this embodiment, the procedure for fabricating such a multi-fiber electrode is as follows: (1) separately create fiber mats by spinning polymer fibers and/or particle/polymer fibers via electrospinning or some other fiber spinning process such as centrifugal spinning, (2) combine/mix the fibers in a solvent (e.g., water or a mixture of water and alcohol), where the solvent may contain additional components like dispersed solid particles, suspended polymer droplets, dissolved polymer, and/or one or more surfactants, and (3) use an ink deposition method (e.g., spraying coating, electrospraying, ultrasonic spraying, slot-die coating, gravure coating, or some other coating method) to form an electrode, where, for example the ink is coated onto a membrane/separator or onto a conductive substrate and the solvent is allowed to evaporate.

In certain embodiments, layered electrodes are made using two or more inks with pre-formed fibers, where the thickness and fiber density of each layer may be varied.

In certain embodiments, the electrode is a layered electrode structure having multiple layers of composite fiber electrodes deposited onto one another.

In certain embodiments, the electrode is a layered or gradient-composition electrode structure formed using multiple different fiber-containing inks.

In certain embodiments, the thickness and porosity of each layer are fixed or variable.

As an example, a fuel cell electrode ink is described in EXAMPLE 4 below, where the ink contains one type of pre-formed particle/polymer fibers in a solvent composed of ethanol and water. The polymer in the fibers was a mixture of a perfluorosulfonic acid ionomer and poly(acrylic acid). The particles are Pt/C (which denotes platinum on carbon). The ink was used to prepare fuel cell electrodes. The electrodes were incorporated into a fuel cell membrane-electrode-assembly (MEA).

A second example of a fuel cell ink and electrode, is described in EXAMPLE 5, where the ink contains pre-formed particle/polymer fibers in an ethanol/water solvent and where the polymer material in the pre-formed fibers is a mixture of perfluorosulfonic acid and poly(ethylene oxide). The particles are Pt/C. The ink was sprayed onto a carbon paper gas diffusion layer to create a fuel cell electrode, which was then incorporated into a fuel cell membrane-electrode-assembly (MEA).

In EXAMPLE 6, an ink was prepared with pre-formed particle/polymer fibers in an ethanol/water solvent with the addition of an aqueous dispersion of fluorinated ethylene propylene and surfactant. The fibers in the ink were composed of Pt/C catalyst particles, perfluorosulfonic acid ionomer and poly(acrylic acid). The ink was used to prepare fuel cell electrodes. The electrode were then used in a fuel cell membrane-electrode-assembly (MEA).

In EXAMPLE 7, an ink containing two different types of fibers with different particles in each is described, where the first fiber type contains Pt/C, perfluorosulfonic aid, and poly(acrylic acid) or poly(ethylene oxide) and the second type of fibers contains a charged or uncharged polymer and ceria particles.

In EXAMPLE 8, a single ink containing two different types of fibers is described for making electrodes for a regenerative fuel cell. One fiber contains oxygen reduction catalyst particles in a binder composed of two or more polymers and the second fiber contains oxygen evolution catalyst particles in a binder composed of two or more polymers.

In EXAMPLE 9, the ink contains two different types of fibers, where the particles are the same in each fiber but the polymer binder in the two fiber types is different.

In EXAMPLE 10, the ink contains one type of pre-formed fibers in an alcohol/water solvent, where the pre-formed fiber contains two different particles, electrochemically active particles such at Pt/C, and chemically active ceria particles, and a binder of two or more polymers.

In EXAMPLE 11, fuel cell polarization plots for two different MEAs which differed in the cathode which were made from different inks are shown.

In certain aspects, the invention also relates to an electrochemical device comprising any one of fiber electrodes as recited above.

These and other aspects of the present invention are further described in the following section. Without intending to limit the scope of the invention, further exemplary implementations of the present invention according to the embodiments of the present invention are given below. Note that titles or subtitles may be used in the examples for the convenience of a reader, which in no way should limit the scope of the invention. Moreover, certain theories are proposed and disclosed herein; however, in no way should they, whether they are right or wrong, limit the scope of the invention so long as the invention is practiced according to the invention without regard for any particular theory or scheme of action.

### Example 1

### Dual Fiber Mat Electrode: Si/PAA+C/PAN Dual Fiber Mat for Li Battery Anodes

To increase electrode stability (resistance to anode degradation due to Si volumetric changes) while providing robust electron conducting pathways that will experience minimal damage (carbon pulverization) during charge/discharge cycling, a dual fiber anode was examined in this exemplary example, with separate Si/PAA (PAA is an abbreviation for polyacrylic acid) and C/PAN (PAN is an abbreviation for polyacrylonitrile) fibers. A schematic diagram of the dual fiber electrospinning apparatus is shown in FIG. 1A, and a top-down SEM image of the dual fiber mat is shown in FIG. 1A.

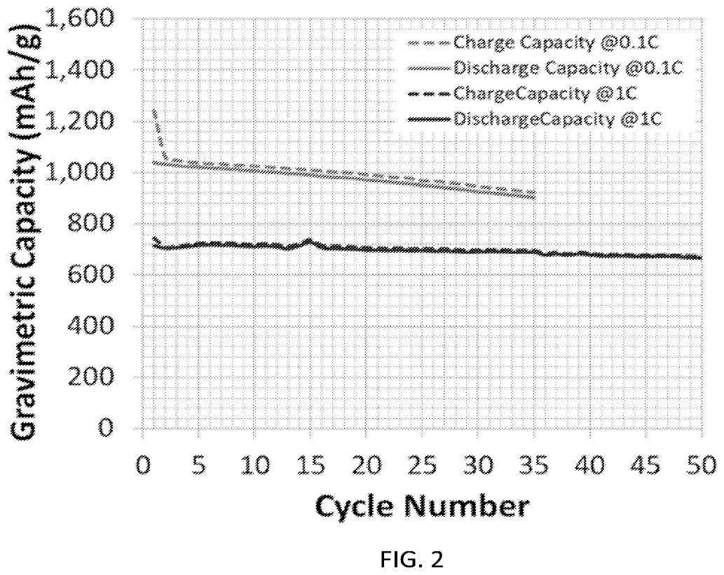

Several dual fiber mats were prepared by electrospinning directly onto a copper foil current collector. A typical set of two electrospinning inks included: (i) 0.3 g Si, 0.3 g PAA, 2 g isopropanol (IPA) and 2 g methanol (MeOH), and (ii) 0.34 g C, 0.2 g PAN and 2.75 g dimethylformamide (DMF). The inks were sonicated for about 30 min and then stirred for 2 days. The dual fiber electrospinning conditions were as follows: (i) C/PAN ink-bias voltage, about 9 kV, distance to collector, about 9.4 cm, flowrate, about 0.25 ml/h, and (ii) Si/PAA ink-bias voltage, about 8 kV, distance to collector, about 7.5 cm, flowrate, about 0.85 ml/h. The difference in Si and carbon compositions of the two inks and the electrospinning flow rates determine the final Si/C content of the dual fiber anode. Electrospinning was carried out in a controlled environment chamber at a relative humidity of about 30% and a temperature of about 24° C. The mat was exposed to solvent vapor and hot pressed to decrease the electrode porosity and then dried in a vacuum oven at about 70° C. for 1 hour and then at about 110° C. overnight. The final anode mat composition for the two inks was: about 70 wt. % Si/PAA fibers (with a fiber composition of about 50/50 wt. ratio of Si/PAA) and about 30 wt. % C/PAN fibers (with an about 63/37 fiber wt. ratio of C/PAN). A coin cell was assembled as in previous experiments with a Li metal cathode and an electrolyte of 1.2 M LiPF in a mixture of ethylene carbonate and diethyl carbonate (3/7 by volume, BASF Corp.) with about 30 wt. % fluoroethylene carbonate (BASF Corp.). A representative plot of charge/discharge cycling for the half-cell with a dual fiber anode is shown in FIG. 2. Capacity data were collected by first cycling the cell at 0.1 C for 35 cycles and then cycling the same cell at 1 C for 50 cycles. At 0.1 C, the capacity retention after 35 cycles was about 87.4% and at 1 C, it increased to about 93.4%. The theoretical capacity calculated from the anode composition (including the weights of Si, carbon and polymer binders) was about 1311 mAh/g, which was quite close to that recorded after the first cycle. The coulombic efficiency was above 98% during 0.1 C cycling and about 99.4% after 50 cycles at 1 C. Additionally, after 50 cycles at 1 C, the gravimetric capacity was about 671 mAh/g (a capacity retention of about 93.4%).

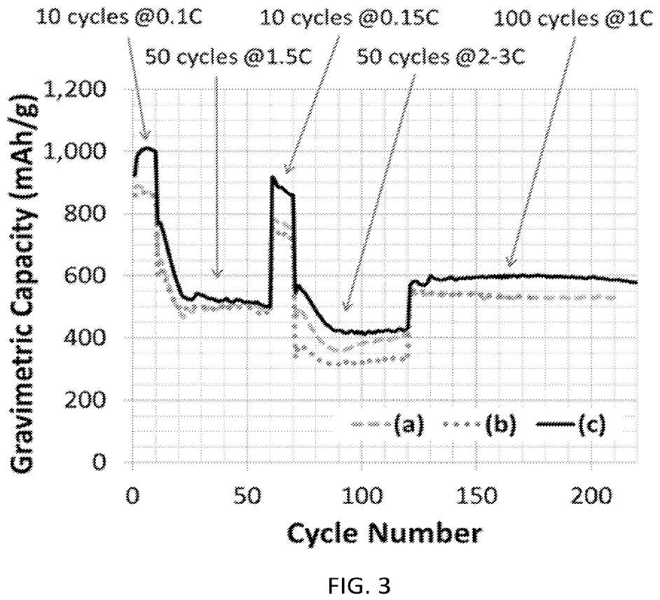

A long-term cycling testing was also performed with selected dual fiber anodes in half-cells. An example is shown in FIG. 3 where the cycling behavior is shown for three cells containing anodes of various Si areal loading: (a) about 0.694 mg_{Si}/cm², (b) about 0.987 mg_{Si}/cm², and (c) about 1.33 mg_{Si}/cm². The first and the second anode had about 50 wt. % PAA in the Si/PAA fibers and the third anode had about 60 wt. % PAA binder. The C/PAN fibers were of the same composition in all three anodes and contained about 63 wt. % C and about 37 wt. % PAN. The best performing cell had an anode with about 1.33 mg_{Si}/cm² with about 40/60 Si/PAA fibers. This anode had an areal capacity of about 0.8 mAh/cm² at 1 C after 170 cycles (where the C-rate was varied from 0.1 C to 2 C).

This same electrode can be made using an ink coating process, where the ink contains a mixture of pre-formed Si/PAA fibers and pre-formed C/PAN fibers or the electrode is made by simultaneously spraying two inks: one ink with pre-formed Si/PAA fiber and one ink containing pre-formed C/PAN fibers.

### Example 2

Mats with Electrospun Si/PAA Fibers and Electrosprayed C/PAI or C/PVDF Droplets

In this exemplary example, a nanofiber-based anode design was examined where Si nanoparticles were electrospun into fibers with PAA binder and carbon was simultaneously electrosprayed as nanodroplets with a polymer binder, either PVDF or PAL. Such a process was used to make a Si+carbon anode for a Li-ion battery. This anode design separates Si and carbon to prevent carbon particle pulverization during charge/discharge cycling. During anode mat preparation, silicon and carbon were deposited from separate spinnerets but while a Si/PAA solution formed continuous fibers by electrospinning, the carbon/binder solution was deposited as nano/micro-droplets via electrospraying.

The potential benefits of an electrospun+electrosprayed anode are, but not limited to, (1) the beneficial high electrode/electrolyte interfacial area for Si/PAA nanofibers is retained, (2) a lower binder content can be used with carbon powder, because well-formed fibers are not needed, thus the electronic conductivity of the C/binder component of the anode is improved, and (3) it is not required that the carbon binder is electrospinnable so a wider range of polymers is available for electrospraying.

A schematic of an apparatus used to make the electrospun/electrosprayed fiber mat electrode is shown in FIG. 4 according to one embodiment of the invention. This figure is only intended to be a schematic example of the required equipment to make an electrospun/electrosprayed mat. Different embodiments of the required equipment may include: (1) the use multiple fiber electrospinning spinnerets and/or spinnerets for electrospraying, (2) the use of spinnerets other than needles to produce fibers and droplets, (3) the use a needleless electrospinning method, (4) the use a nanofiber spinning method that does not involve an electric field (e.g., gas jet fiber spinning or centrifugal spinning), and (5) the use of alternative methods to spray nanodroplets, other than electrospraying, where multiple needles or sources of droplets are used.

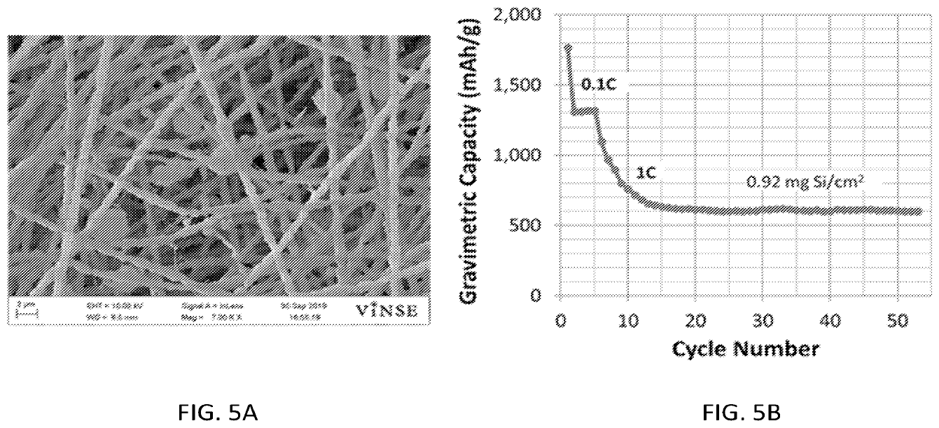

In one example, two polymer were used as the binder for electrospraying carbon: PVDF (Kynar) from Arkema and polyamide-imide (Torlon) from Solvay Specialty Polymers. The first series of experiments were performed with anodes composed of Si/PAA electrospun fibers (about 60/40 w/w Si/PAA) and C/PVDF electrosprayed droplets (about 83/17 w/w C/PVDF), with an overall anode composition of 20 wt. % carbon, 45 wt. % silicon, about 32 wt. % PAA, and about 3 wt. % PVDF. The ratio of Si fibers to C droplets was varied and the total amount of material comprising the anode differed to achieve different Si areal loadings. A representative SEM image of a spun/sprayed mat is shown in FIG. 5A (the Si areal loading was about 0.92 mg/cm²). Electrosprayed nanodroplets can be seen interspersed between Si/PAA fibers and there appears to be some C/PVDF deposited onto the Si fibers. A similar morphology was seen with mats composed of Si/PAA fibers+C/PAI nanodroplets. Anode mats were further processed by interfiber welding and annealing for 2 h at 120° C. Anodes were evaluated in a CR2032 coin cells with a Li metal counter/reference electrode and an electrolyte of 1.2 M LiPF6 in 3/7 EC/EMC with about 10 wt. % FEC additive. Galvanostatic charge/discharge experiments were conducted by polarizing the cells between about 0.015 and about 1.5 V vs. Li/Li+. Cycling performance of a Si/PAA-C/PVDF anode with areal loading of 0.92 mg_{Si}/cm² is shown in FIG. 5B (0.1 C for 5 cycles and then 1 C for 50 cycles). At 1 C, the anodes exhibited an initial (10 cycles) drop in gravimetric capacity followed by about 93% capacity retention over the remaining about 40 cycles. The terminal gravimetric capacity was about 600 mAh/g and the terminal areal capacity was about 1.15 mAh/cm².

In another example, fiber mats were prepared by electrospinning a Si/PAA ink and electrospraying a carbon/polyamide-imide ink. The Si/PAA ink contained about 7.8 wt. % Si nanoparticle (about 50-100 nm) and about 5.21 wt. % PAA in a solvent mixture of n-propanol and methanol. The C/PAI ink included about 4.6 wt. % carbon black nanoparticles (about 50 nm avg.) and about 0.9 wt. % polyamide-imide (Torlon, Solvay Polymers) mixed in DMF. The overall composition of the final anode mats was about 20 wt. % carbon, about 45 wt. % Si nanoparticles, and about 35 wt. % binder (about 60/40 w/w Si/PAA fibers and about 83/17 w/w C/PAI). The electrospraying conditions were as follows: Voltage=13.8 kV, Tip to collector distance=10 cm, flow rate=0.6 mL/hr, RH=30%. The electrospinning conditions were as follows: Voltage=8.2 kV, tip to collector distance=11 cm, solution flow rate=0.9 mL/hr, RH=30%.

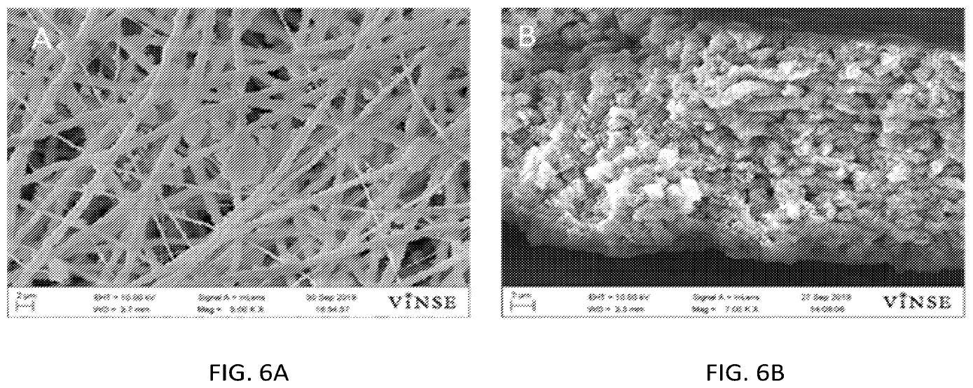

Prepared mats were compacted and welded. SEM images show a wide range of particle sizes, from as small as 100 nm to larger 4 μm particles (see, for example, FIG. 6A). The C/PAI ink is able to achieve smaller particle diameters, allowing for a more even coating of carbon on Si/PAA fibers throughout the mat, thus allowing for increased electrical conductivity. After densification and welding, the fiber structure retained through an anode mat, as indicated by the SEM fiber mat cross section shown in FIG. 6B.

CR2032 half-cells were constructed in an argon-filled glovebox using a welded/compacted fiber/sprayed mat anode on a Cu-foil current collector (10 mm in diameter) and a Li metal counter/reference electrode. The electrolyte was 1.2 M LiPF6 in a mixture of ethylene carbonate and ethyl methyl carbonate (EC/EMC 3/7 by volume, BASF Corp.). 10 wt. % fluoroethylene carbonate (BASF Corp.) was added to the electrolyte to stabilize the solid electrolyte interphase (SEI) layer. Single sheets of Celgard 2500 soaked in electrolyte were used as the separator to prevent short-circuiting of the cells during crimping, and several additional drops of electrolyte were added to completely fill the cell volume. Cells were crimped at 1000 psi and rested overnight before electrochemical characterization. All coin cells in this study were fabricated using the same method. Galvanostatic charge/discharge experiments were conducted by polarizing the cells between about 0.015-1.5 V vs. Li/Li+at 0.1 C (about 0.2 mA/cm²) for 5 cycles and then at 1 C (about 1.27 mA/cm²) for 100 cycles, using an 8-channel battery tester (5 V/10 mA, MTI Corp.). C-rates for the half-cells were calculated assuming a theoretical capacity of about 3600 mAh/g for Si and about 310 mAh/g for carbon. Half-cell capacities were normalized with respect to the entire weight of an anode (i.e., total amounts of Si, C, PAA and PAI).

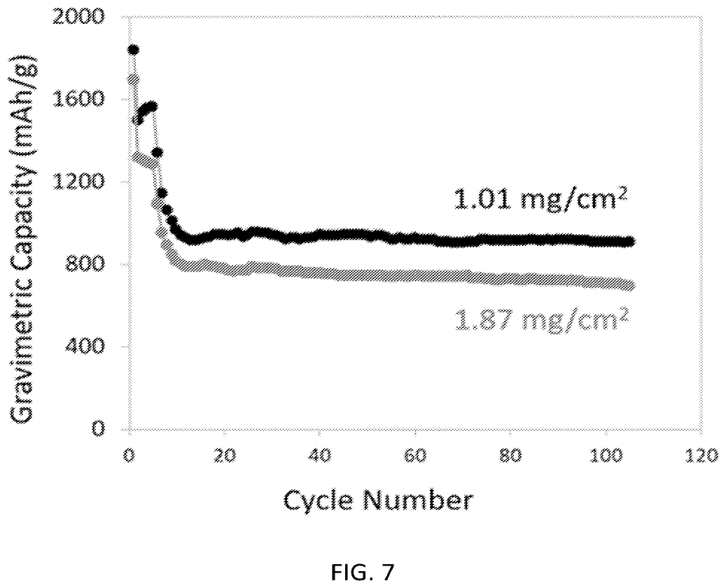

Gravimetric capacity versus cycle number for two selected Si/PAA+C/PAI anodes is shown in FIG. 7. The anodes exhibited a high first cycle capacity, effectively utilizing all of the silicon in the mat. Lower loadings (about 1.01 mg/cm² total with about 0.46 mg/cm² silicon) achieved higher gravimetric capacities, with a terminal capacity of about 900 mAh/g at cycle 100 and an areal capacity of about 0.92 mAh/g. At the higher loading, there was some capacity fade, to about 700 mAh/g at the 100th cycle, but this anode had a higher areal capacity of about 1.29 mAh/cm² with about 0.89 mg_{Si}/cm². Most importantly, these anodes performed well over extended cycle numbers, offering about 90-99% capacity retention during 1 C cycling for 100 charge/discharge cycles with a coulombic efficiency>99%.

In these exemplary examples, Si+carbon dual fiber electrospun mats (EXAMPLE 1) and electrospun/electrosprayed fiber mats (EXAMPLE 2) are shown. The invention, however, is not limited to Si anodes in a Li-ion battery. They can be used as electrodes (anode and/or cathode) in: (1) batteries other than Li-ion batteries, (primary, secondary, and redox flow batteries), (2) proton exchange membrane and alkaline fuel cells, (3) electrolyzers, (4) electrochemical reactors, including those for inorganic and organic synthesis and those used for CO₂ reduction, (5) sensors, (6) capacitors, and (7) other electrochemical devices. The general spin/spray fiber mat configuration can also be used in non-electrochemical applications. Various aspects of the invention also relate to (i) a composite electrode where one of the electrospun fibers and/or one of the types of droplets contains no particles and (ii) a composite electrode composed of multiple particle/polymer droplets and no fibers.

This same electrode can be made by coating or spraying an ink that contains pre-formed Si/PAA fibers, carbon powder, and either PAI, PVDF, or mixtures thereof in a common solvent. Alternatively, the electrode can also be made by: (1) simultaneously spraying an ink containing pre-formed Si/PAA fibers and an ink containing carbon powder and PAI, PVDF, or mixture thereof, or (2) creating a fiber electrode by coating/spraying an ink containing pre-formed fibers, allowing the solvent in the ink to evaporate, and then spraying an ink of carbon power and a polymer such as PAI or PVDF onto the as-formed dry fiber electrode.

### Example 3

Fuel Cell Electrodes Made from Inks Containing Fibers

In this exemplary example, electrospinning inks were prepared by dispersing about 46 wt. % Pt/C (TEC10F50E from TKK), sodium form Nafion® (Liquion LQ-1115 from Ion-Power), and poly(ethylene oxide) (PEO, 600 kDa from Sigma Aldrich) into a water/alcohol mixture. The solids made up about 12 wt. % of the ink and was about 52:37:11 Pt/C:Nafion® (Na+):PEO by weight percent. The water/alcohol mixture was composed of water:n-propanol:methanol. The ink was mechanically mixed and then electrospun using a single needle spinneret, a 20 cm tip-to-collector distance, about 9 kV, 0.75 ml/hr ink flowrate, and about 20% relative humidity. It should be noted that a variety of hydrogen/air fuel cell electrodes can be prepared using this technique, including different catalysts such as PtCo/C and PtNi/C, different equivalent weight ionomers in the salt or acid form, and other carrier polymers, including but not limited to PAA and PVDF. Ink ratios and electrospinning conditions may vary for these different electrode materials.

After electrospinning, fiber mats were dried under vacuum to remove any residual solvent and then thermally annealed. Post annealing, fibers were placed into a vial with a 9:1 water:IPA wt. ratio mixture. The solids content was about 4 wt. %. The fiber ink was subjected to about 1-5 minutes of sonication in a sonic bath and then mechanically mixed.

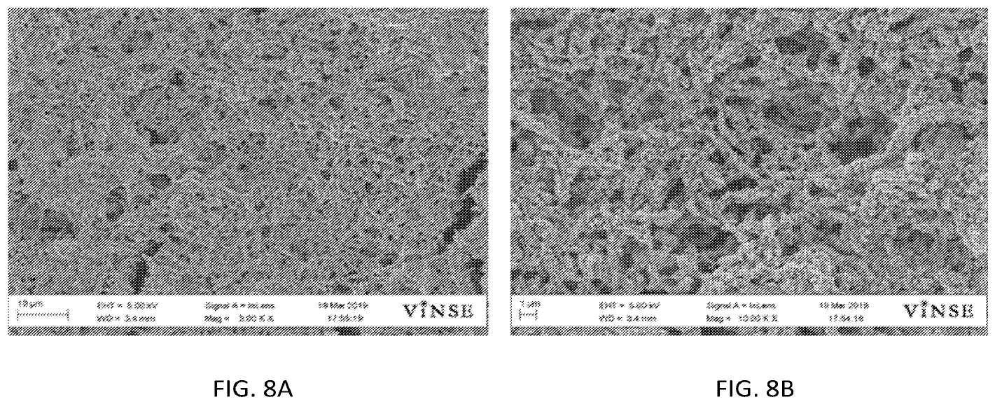

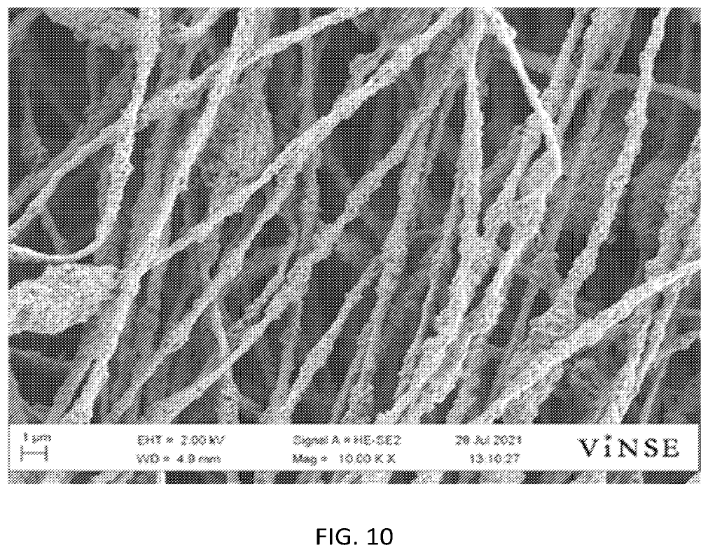

The fiber-based ink can be used to prepare electrodes by spraying, die-slot coating or some other coating method. The ink can be used directly and is amenable to conventional methods of preparing fuel cell electrodes. For sprayed electrodes, the ink was sprayed onto gas diffusion layers until the desired gravimetric catalyst loading was achieved. A sample of the sprayed electrode was collected for SEM imaging. As shown with SEM images of re-dispersed fiber electrodes at 3 kX magnification (FIG. 8A) and 10 kX magnification (FIG. 8B), the fiber morphology has clearly been retained after spraying the fiber-based ink. After drying, the gas diffusion electrodes were hot-pressed onto either side of a proton exchange membrane to create a membrane-electrode-assembly (MEA).

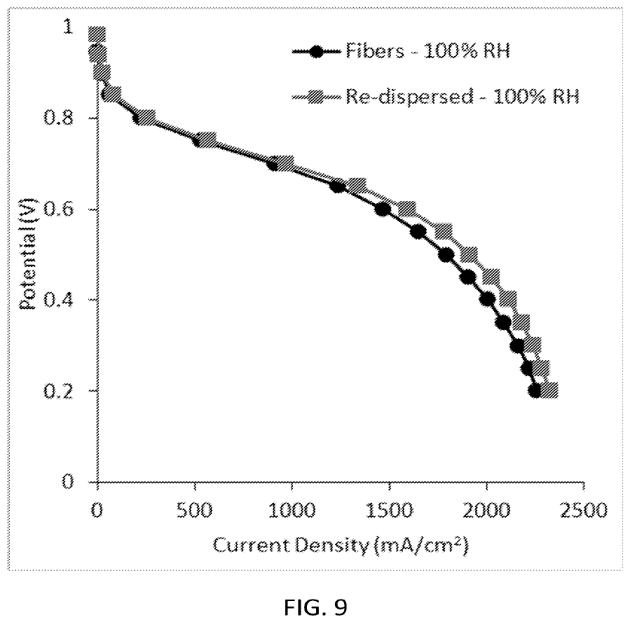

The MEA was loaded into a fuel cell test stand and H₂/air fuel cell performance was evaluated using procedures described in the literature. Polarization data of the re-dispersed fiber electrodes is contrasted with fiber mat electrodes made by directly electrospinning fibers onto carbon. FIG. 9 illustrates polarization data for as-spun fiber electrodes (black) and re-dispersed fiber electrodes (red) at 100% (filled) and 40% (unfilled) relative humidity. Data were collected at 80° C., 200 kPa_{abs}, and 125/500 sccm of H₂/air at the anode and cathode, respectively. The data show that at both low and high relative humidity, re-dispersed fiber electrodes (i.e., electrodes made by spraying an ink with fibers) produce similar power as compared to an MEA with as-spun fiber electrodes (no re-dispersion of the fibers).

### Example 4

Fuel Cell Electrodes Made from Inks Containing Nafion/PEO Fibers

In this exemplary example, electrospun fibers were prepared with Pt/C catalyst particles, sodium form perfluorosulfonic acid (PFSA), and poly(ethylene oxide) (PEO). The fiber weight percent composition was about 52/37/11 catalyst/PFSA/PEO. It should be noted that a variety of different hydrogen/air fuel cell electrode fiber can be substituted for that used in this example, where different catalysts are used such as PtCo/C and PtNi/C, different ion exchange capacity ionomers are used in the salt or acid form, and other carrier polymers are used, including but not limited to PAA, PVP, and PVDF.

After electrospinning, the fiber mat was dried under vacuum to remove any residual solvent and then thermally annealed at about 140° C. Post annealing, the fiber mat was thoroughly mixed with water and ethanol using a combination of mechanical stirring and/or sonication. The final ink had a 3/1 water/ethanol solvent weight ratio with about 5 wt % fibers.

The fiber-based ink was used to prepare electrodes by air-brush spraying. In this example, the ink was sprayed onto a gas diffusion layer until the desired gravimetric catalyst loading was achieved. After drying, the anode and cathode gas diffusion electrodes were hot-pressed onto the opposing sides of a proton exchange membrane to create a membrane-electrode-assembly (MEA). Scanning electron microscope images of as-spun particle/polymer fibers and the fibers in the ink (shown after spraying the ink onto a carbon paper gas diffusion layer) are shown in FIG. 10. The image shows fibers, proving that the fiber shape is retained after such fibers are made into a liquid ink by mixing with a water/alcohol solvent. There was no indication of fiber disintegration or physical deterioration in the ink.

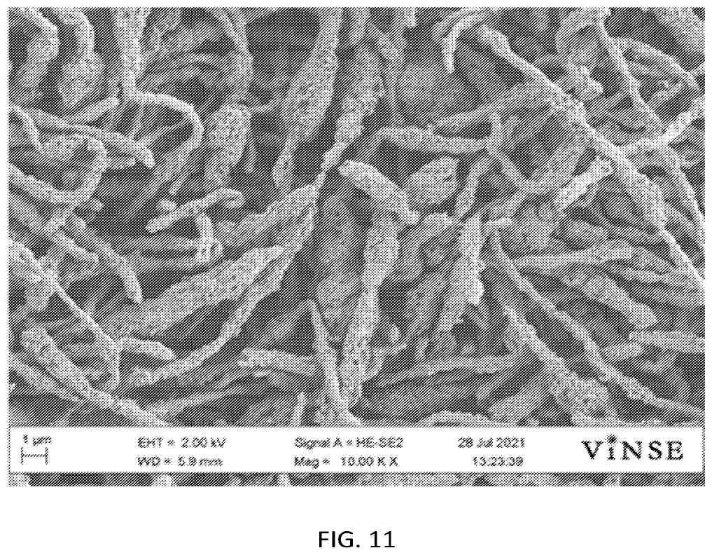

The MEA was loaded into a fuel cell test stand and H₂/air proton exchange membrane fuel cell performance was evaluated using procedures described in the literature. Polarization data of the re-dispersed fiber electrodes is contrasted with fiber mat electrodes made by directly electrospinning fibers onto carbon. FIG. 11 illustrates polarization data for as-spun fiber electrodes (black) and re-dispersed fiber electrodes (red) at 100% (filled) and 40% (unfilled) relative humidity. Data were collected at 80° C., 200 kPa_{abs}, and 125/500 sccm of H₂/air at the anode and cathode, respectively. At low and high relative humidity operation, the MEA made with an ink with pre-formed fibers produced high power.

### Example 5

Fuel Cell Electrodes Made from Inks Containing Nafion®/PAA Fibers

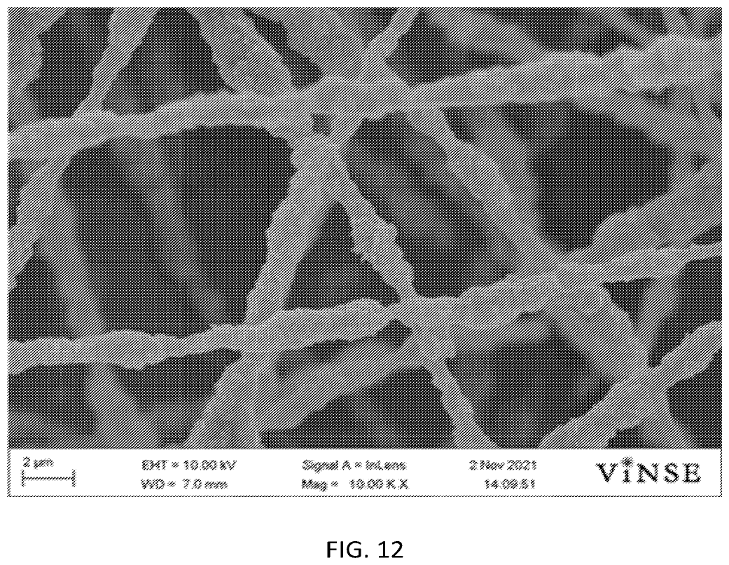

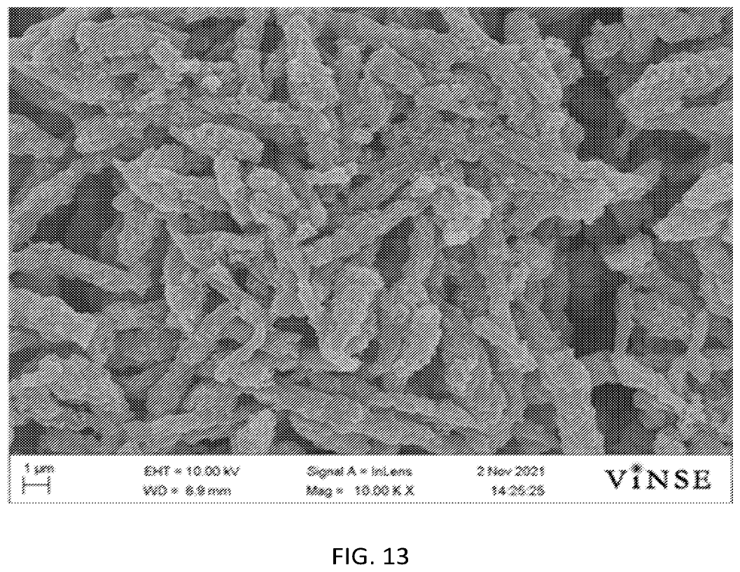

In this example, electrospun fibers were prepared from Pt/C catalyst powder, perfluorosulfonic acid (PFSA) ionomer, and poly(acrylic acid) (PAA) as a carrier polymer. The dry fiber weight fraction composition was about 58/28/14 catalyst/Nafion®/PAA. The fiber mat was then made into an ink. First the fiber were annealed at 140° C. Then they were mixed with water and ethanol. The final ink had a solids content of about 4%, where the water/ethanol ratio was between about 2.3/1 and 2.5/1. Scanning electrode microscope images of the as-spun fibers and fibers from an ink after ink deposition on a carbon support after air-brush spraying and solvent evaporation are shown in FIG. 12. The fibers remain intact after dispersing in an alcohol/water solvent. H₂/air fuel cell polarization data are shown in FIG. 13, indicating that the ink contained particle/polymer fibers. The ink was spray coated onto carbon paper gas diffusion layers which were then used to prepare a membrane-electrode-assembly (MEA) for fuel cell testing. The MEA worked well in a hydrogen/air proton exchange membrane fuel cell, with high power and good durability.

### Example 6

Fuel Cell Electrodes Made from Inks Containing Nafoin/PAA Fibers and a Polymer Disperion
In this example, an ink was prepared from pre-formed fibers composed of Pt/C catalyst, perfluorosulfonic acid (PFSA) ionomer, and polyacrylic acid (PAA), where the dry fiber weight fraction composition was about 58/28/14 catalyst/PFSA/PAA. To make an ink, the particle/polymer fibers were annealed and then mixed with water and ethanol. Fibers were added to the ink also contained a dispersion of fluorinated ethylene propylene stabilized with a non-ionic surfactant. After mixing, an aqueous dispersion of fluorinated ethylene propylene (FEP) with a non-ionic surfactant (Teflon™ FEPD 121 from Chemours Company FC, LLC) was added to ink with additional mixing. The resulting ink had a solids content of 4 wt %, a water/ethanol weight ratio of about 2.4 and a final catalyst/PFSA/PAA/FEP/surfactant ratio of 49/24/12/10/5. The ink was spray coated onto a carbon paper gas diffusion layer and fully dried. MEAs were prepared from the catalyst-coated gas diffusion layers and then tested in a H₂/air proton exchange membrane fuel cell, operating at 80° C. The resulting polarization curve is shown in FIG. 13. Inks with the pre-formed fibers were also made using an alcohol/water solvent, where the FEP dispersion was replaced by either a polytetrafluoroethylene dispersion or a poly(vinylidene fluoride dispersion, for example, Teflon™ PTFE DISP 30 from Chemours or a LBG2200LX Kynar Flex® emulsion from Archema.

The inks were used to prepare fuel cell electrodes by spray coating onto carbon paper gas diffusion electrodes. Hydrogen/air proton exchange membrane fuel cell test showed that the electrodes produced high power.

### Example 7

An Ink and Electrode for a Fuel Cell Containing Two Different Types of Fibers Each with Different Particles

In this example, the ink contains two different types of fibers. One fiber has an electrochemically active electrocatalyst particle and the second type of fibers has a particle that does not participate directly in an electrochemical reaction. As an example of two-fiber ink and electrode, the first type of fibers contains Pt/C and/or Pt-alloy/C particles with a charged hydrocarbon polymer binder or a charged fluoropolymer such as a perfluorosulfonic acid binder, optionally with a second polymer like PAA, PEO, PVP, or PVDF, and the second type of fibers contains a charged or uncharged polymer such as PVDF, polysulfone, polyamidimide, or perfluorosulfonic acid and ceria particles. Also, in this example are the electrode and the membrane-electrode-assembly (MEA) that is fabricated from the ink, where the electrode is composed of two different types of particle/polymer fibers and where said electrode is incorporated into a MEA.

### Example 8

### An Ink Containing Two Different Fibers for a Regenerative Fuel Cell

In this example, the ink contains two different types of fibers. One fiber has one type of electrochemically active particle and the second type of fibers has a second type of electrochemically active particle, where the two particles differ in composition and/or function in the electrode. As an example, of this type of ink is a dual fiber mat electrode for a regenerative H₂/O₂ or H₂/air fuel cell. The ink is contains a first fiber type made with an oxygen reduction reaction catalyst, such as Pt-black, Pt/C and/or Pt-alloy/C with a charged hydrocarbon polymer binder or a charged/uncharged fluorinated polymer binder, such as a perfluorosulfonic acid binder, optionally with a second polymer such as PAA, PEO, PVDF, or PVP for fiber spinning and a second type of fibers that contains an oxygen evolution catalyst such as Ir or IrO₂ in a charged hydrocarbon polymer or a charged fluoropolymer polymer like perfluorosulfonic acid or an uncharged hydrocarbon polymer like poly(phenylsulfone) and a fluorinated polymer such as poly(vinylidene fluoride) optionally with a fiber spinning carrier polymer like PAA, PEO, PVP, or PVDF. Also, as part of this example are the electrode and membrane-electrode-assembly that contains dual fiber electrodes for hydrogen oxidation/reduction and oxygen evolution/reduction.

### Example 9

An Ink for Electrodes Containing Two Different Types of Fibers with Different Polymer Binders in Each

In this example, the ink contains two different types of fibers. One fiber type has an one type of electrochemically active particle and polymer binder and the second type of fibers has the same electrochemically active particle but a different polymer binder. As an example, the first fiber type contains Pt/C and/or Pt-alloy/C particles and a charged polymer, such as a charged hydrocarbon polymer or a charged fluoropolymer such as perfluorosulfonic acid, optionally with a fiber spinning carrier polymer such as PAA, PEO, or PVP and the second type of fibers contains the same Pt/C and/or Pt-alloy/C particles and a binder which is PVDF or a mixture of PVDF and a charged polymer such as perfluorosulfonic acid or a copolymer of PVDF and a charged polymer such as a perfluorosulfonic acid. This example includes the electrode made from this ink and the MEA made from said electrode.

### Example 10

An Ink for Electrodes Containing One Type of Fiber with Two Different Particles

In this example, the ink contains one fiber type, but the fiber contains two different particles. For this example, the fiber contains two different particles such as Pt/C and Pt-alloy/C particles or Pt/C and Ceria particles with a charged hydrocarbon polymer or a charged fluoropolymer such as a perfluorosulfonic acid, optionally with a fiber spinning carrier polymer such as PAA, PEO, PVP, or PVDF.

### Example 11

Fuel Cell Polarization for Two Different Meas which Differed in the Cathode

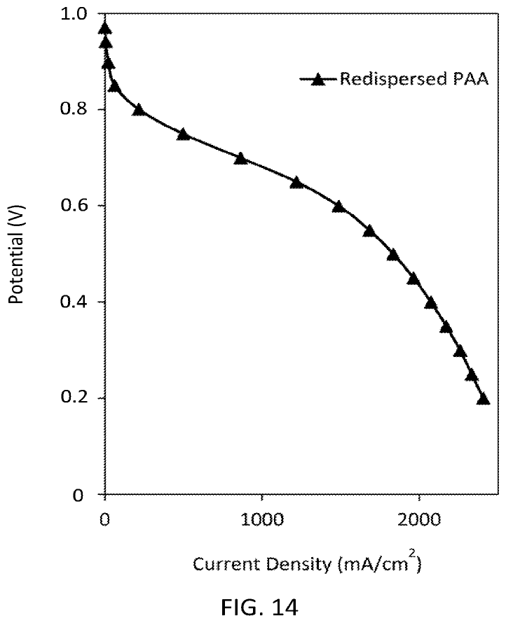

FIG. 14 shows fuel cell polarization plots for two different MEAs which differed in the cathode, where one MEA had a cathode that was made by spraying an ink containing Pt/C powder and Nafion® in an alcohol/water solvent (identified as the sprayed electrode in the figure). The second MEA had a cathode made from an ink containing pre-formed Pt/C/polymer fibers, where the fibers were made with Pt/C, Nafion®, and PAA. The anode for both MEAs was made by spraying an ink containing Pt/C and Nafion® in an alcohol/water solvent. Fuel cell operating conditions: 80° C., 200 kPa (abs) pressure, 100% relative humidity, 0.1 mg/cm² Pt loading for the anode and cathode, Nafion® 211 membranes, and H₂/air flow rates (sccm) of 125/500.

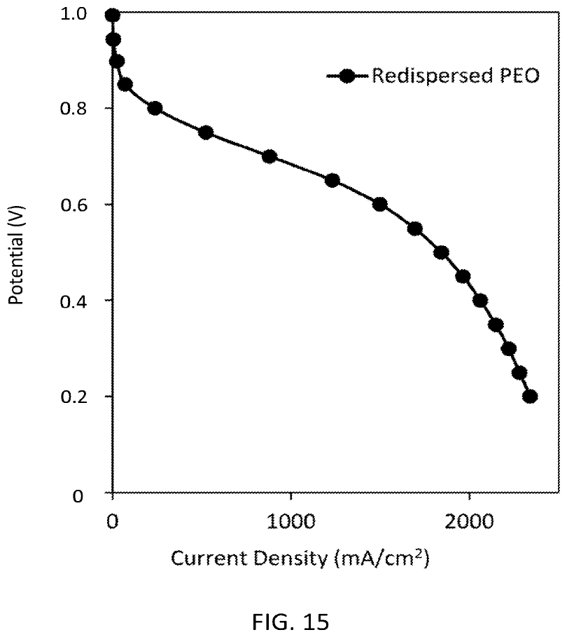

FIG. 15 shows fuel cell polarization plots for two different MEAs which differed in the cathode, where one MEA had a cathode that was made by spraying an ink containing Pt/C powder and Nafion® in an alcohol/water solvent (identified as the sprayed electrode in the figure). The second MEA had a cathode made from an ink containing pre-formed Pt/C/polymer fibers, where the fibers were made with Pt/C, Nafion®, and PEO. The anode for both MEAs was made by spraying an ink containing Pt/C and Nafion® in an alcohol/water solvent. Fuel cell operating conditions: 80° C., 200 kPa (abs) pressure, 100% relative humidity, 0.1 mg/cm² Pt loading for the anode and cathode, Nafion® 211 membranes, and H₂/air flow rates (sccm) of 125/500.

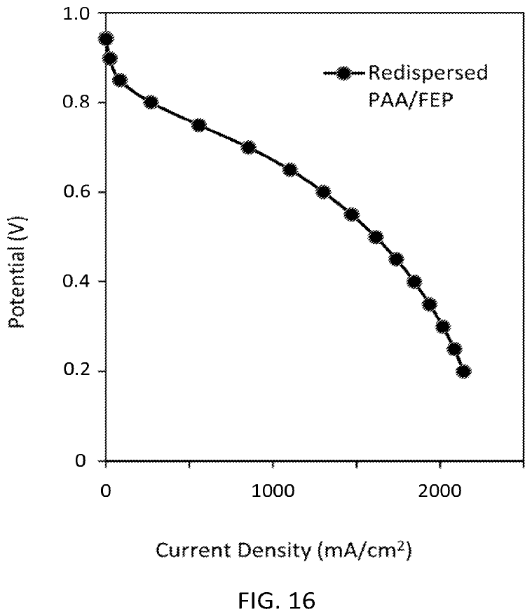

FIG. 16 shows fuel cell polarization plots for two different MEAs which differed in the cathode, where one MEA had a cathode that was made by spraying an ink containing Pt/C powder and Nafion® in an alcohol/water solvent (identified as the sprayed electrode in the figure). The second MEA had a cathode made from an ink containing pre-formed Pt/C/polymer fibers and a dispersion of fluorinated ethylene propylene polymer with surfactant (Teflon™ FEPD 121), where the fibers were made with Pt/C, Nafion®, and PAA. The anode for both MEAs was made by spraying an ink containing Pt/C and Nafion® in an alcohol/water solvent. Fuel cell operating conditions: 80° C., 200 kPa (abs) pressure, 100% relative humidity, 0.1 mg/cm² Pt loading for the anode and cathode, Nafion® 211 membranes, and H₂/air flow rates (sccm) of 125/500.

In any of the above examples with multiple fiber inks, the ink may also contain a dispersion of polymer micelles and/or a charged or uncharged surfactant. For these and other multi-fiber type inks, the inks with pre-formed fibers are used to prepare electrodes by a spraying or direct coating method. The fibers may have a solid core-shell morphology or the fibers may have a hollow core.

The foregoing description of the exemplary embodiments of the invention has been presented only for the purposes of illustration and description and is not intended to be exhaustive or to limit the invention to the precise forms disclosed. Many modifications and variations are possible in light of the above teaching.

While there has been shown several and alternate embodiments of the present invention, it is to be understood that certain changes can be made as would be known to one skilled in the art without departing from the underlying scope of the invention as is discussed and set forth above and below including claims and drawings. Furthermore, the embodiments described above are only intended to illustrate the principles of the present invention and are not intended to limit the scope of the invention to the disclosed elements.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in the description of this invention are incorporated herein by reference in their entireties and to the same extent as if each reference was individually incorporated by reference.

1. An ink, comprising:
a dispersion of fibers in at least one solvent, wherein said fibers have one or more fiber types, wherein at least one type of said fibers comprises at least one particle type for an electrochemical reaction and at least one binder polymer.

2. The ink of claim 1, wherein the at least one particle type comprises electrochemically active particles or electronically conductive particles with no or minimal electrochemical activity.

3. The ink of claim 2, wherein the at least one particle type comprises a catalyst composed of a metal or alloy on a catalyst support, or a metal or alloy with no support.

4. The ink of claim 3, wherein the at least one particle type comprises Pt, Pd, Rh, Ru, Ir, IrO₂, Au, Ag, Ni, Zn, Ti, Mo, Co, Fe, W, Cu, Cr, Ta, or a mixture or blend or alloy thereof.

5. The ink of claim 4, wherein the at least one catalyst comprises one or more of
a platinum-group-metal (PGM) on the catalyst support;
PGM-free particles including Fe—N—C particles, Ir, IrO₂, precious metal alloy catalysts on the catalyst support including PtCo/C or PtNi/C; and
PGM black catalysts with no support including Pt-black, Pd-black, Pd-black alloys and Pt-black alloys, carbon and graphite powders, detonation diamond powder, core-shell and shape controlled catalyst particles, catalysts for oxygen reduction in alkaline media including Ag and Ni.

6. The ink of claim 3, wherein the catalyst support comprises carbon, or oxides or carbides of metals including Si, Mo, Ti, or Al.

7. The ink of claim 1, wherein the at least one binder polymer is an ionomer comprising uncharged repeat units and repeat units with charged/ionizable repeating units.

8. The ink of claim 1, wherein the at least one solvent comprises water, or a water/organic mixed solvent.

9. The ink of claim 9, wherein an organic component of the water/organic solvent is an alcohol.

10. The ink of claim 9 wherein the alcohol is ethanol.

11. The ink of claim 9, wherein the at least one solvent further comprises a dispersion of at least one polymer that may contain fluorine.

12. The ink of claim 11, wherein the at least one fluorine-containing polymer is polytetrafluoroethylene (PTFE), polyvinylidene fluoride (PVDF), or fluorinated ethylene propylene (FEP).

13. The ink of claim 11, wherein the at least one solvent further comprises one or more ionic or nonionic surfactants, and/or one or more polymer dispersants.

14. The ink of claim 11, wherein the at least one solvent further comprises one or more particles.

15. The ink of claim 14, wherein the one or more particles are ceria particle and/or one or more electrocatalyst particles.

16. The ink of claim 1, wherein the at least one catalyst comprises two or more different catalysts, and the at least one binder polymer comprises two or more different polymers.

17. The ink of claim 1, wherein the at least one type of said fibers further comprises a carrier polymer.

18. The ink of claim 17, wherein the carrier polymer comprises polyethylene oxide (PEO), poly(acrylic acid) (PAA), polyvinyl alcohol (PVA), polyvinylpyrrolidone (PVP), polyethylene glycol (PEG), or a mixture thereof.

19. The ink of claim 18, wherein the at least one catalyst comprises Pt/C, Pt/Co/C, PtNi/C, or ceria particles and the at least one binder polymer comprises perfluorosulfonic acid.

20. The ink of claim 19, wherein at least another type of said fibers comprises fibers containing Ir or IrO₂, or ceria particles in a binder of one or more polymers.

21. The ink claim 1, wherein said fibers comprise two or more different particle/polymer fiber types, wherein each particle/polymer fiber type comprises a catalyst and a polymer.

22. The ink claim 1, wherein said fibers comprise one or more different particle/polymer fiber types and one or more different polymer fiber type, wherein each particle/polymer fiber type comprises a catalyst and a polymer, and each polymer fiber type comprises one or more polymers.

23. The ink claim 1, wherein said fibers differ by one or more of
a type of particles;
a type of the binder;
a binder/catalyst ratio;
intra-fiber porosity;
fiber morphology; and
particle loading.

24. The ink claim 1, wherein said fibers are pre-formed by electrospinning, gas jet spinning, or centrifugal spinning, or some hybrid combination thereof.

25. An electrode, being fabricated using the ink of claim 1.

26. The electrode of claim 25, being fabricated with a single ink with a uniform ink distribution in the electrode thickness direction.

27. An electrode, being fabricated using multiple different inks, each ink has a formulation according to claim 1, wherein at least one type of said fibers in each ink contains one or more catalyst and one or more polymers.

28. The electrode of claim 27, wherein each of said multiple different inks comprises pre-formed fibers, wherein the electrode has a layered morphology in the electrode thickness direction, wherein the layers differ in thickness and/or fiber morphology and/or fiber composition.

29. The electrode of claim 27, comprising multiple layers, wherein each layer is made by a respective ink, wherein said inks differ in fiber content, fiber diameter and porosity, fiber composition, solvent, type and the presence or absence of dispersed polymer droplets and/or surfactant.

30. The electrode of claim 28, being fabricated by a spraying, electrospraying, ultrasonically spraying, or coating process.

31. The electrode of claim 30, wherein the coating process is a die-slot coating process, a gravure process, or a process that utilizes Meyer rods or similar devices.

32. The electrode of claim 27, being an electrospun fibrous mat electrode comprising a catalyst powder, an ionomer, and a dispersed uncharged polymer.

33. The electrode of claim 27, being fabricated with two or more inks, wherein the two or more inks are sequentially deposited in the electrode thickness direction.

34. The electrode of claim 27, being fabricated with two or more inks, wherein the two or more inks are simultaneously deposited during electrode fabrication.

35. The electrode of claim 27, being fabricated with two or more different inks, wherein the two or more inks are simultaneously deposited during electrode fabrication, wherein the flow rate of ink deposition for each ink is continuously varied to create a continuous gradient electrode composition.

36. The electrode of claim 27, being fabricated from two or more inks, wherein a gradient composition exists in the fiber composition in the planar electrode direction and/or in the electrode thickness direction.

37. The electrode of claim 27, being fabricated from two or more inks, wherein a variation exists in fiber composition in the direction perpendicular and/or parallel to the electrode thickness.

38. The electrode of claim 27, being a Si anode for a Li-ion battery.

39-53. (canceled)
